(19) United States
(12) Patent Application Publication
(10) Pub. No.: US 2006/0120401 A1
(43) Pub. Date: Jun. 8, 2006

(54) Method and apparatus for managing information on parts, and computer product

(76) Inventors: Kohsuke Harada, Kanagawa (JP); Fujio Nakamura, Kanagawa (JP); Yuuichi Ohta, Kanagawa (JP)

Correspondence Address: MORRISON & FOERSTER LLP, 1650 TYSONS BOULEVARD, SUITE 300, MCLEAN, VA, 22102, US

(21) Appl. No.: 11/293,107

(22) Filed: Dec. 5, 2005

(30) Foreign Application Priority Data
Dec. 7, 2004 (JP) 2004-354728

(51) Int. Cl. H04J 3/22

(52) U.S. Cl. 370/465

(57) ABSTRACT

An apparatus for managing information on at least one part to be used to manufacture a product includes a part-data creating unit configure to create part data that includes information on a part designated by a customer to be used to manufacture a product; a common-function-part data creating unit configured to create common-function-part data that includes at least two common-function-parts that have substantially common functions and priority information of each of the common-function-parts; an acquiring unit configured to acquire replacement-possibility data indicative of whether replacement of designated part with an alternative part is possible; an extracting unit configured to extract an alternative part for the designated part based on the common-function-part data; a determining unit configured to determine whether to replace the designated part with the alternative part based on the common-function-part data and the replacement-possibility data.

### CROSS-REFERENCE TO RELATED APPLICATIONS

The present document incorporates by reference the entire contents of Japanese priority document, 2004-354728 filed in Japan on Dec. 7, 2004.

### BACKGROUND OF THE INVENTION

1. Field of the Invention

The present invention relates to a technology for managing information on parts to be used to manufacture a product.

2. Description of the Related Art

In an electronics manufacturing service, a service provider company accepts an order from a customer and manufactures customized a printed circuit board. When the customer places the order, the customer provides a design for the printed circuit board and designates parts for the printed circuit board to the service provider company. The service provider company manufactures the printed circuit board based on the design and designation of parts. The parts to be mounted on such printed board vary in manufacturers, specifications, and prices. Many systems for managing such diverse types of parts have been developed. Japanese Patent Application Laid-open No. 2002-99591, for example, discloses a system that manages data on parts that are approved as purchase targets based on predetermined criteria.

However, if each customer designates parts to be used for each customized product, it is necessary to prepare many types of parts according to the designation. If the parts of each type are purchased in small quantities, a cost of the parts increases. Accordingly, a cost of the printed circuit board increases. In addition, if designated parts are out of stock, it is necessary to for the service provider company to procure them. This can be a cause to delay delivery of the product.

### SUMMARY OF THE INVENTION

It is an object of the present invention to at least solve the problems in the conventional technology.

A method according to one aspect of the present invention is of managing information on at least one part to be used to manufacture a product. The method includes creating part data that includes information on a part designated by a customer to be used to manufacture a product; creating common-function-part data that includes at least two common-function-parts that have substantially common functions and priority information of each of the common-function-parts; acquiring replacement-possibility data indicative of whether replacement of designated part with an alternative part is possible; extracting an alternative part for the designated part based on the common-function-part data; determining whether to replace the designated part with the alternative part based on the common-function-part data and the replacement-possibility data.

A computer-readable recording medium according to another aspect of the present invention stores therein a computer program for realizing a method according to the above aspect.

An apparatus according to still another aspect of the present invention is for managing information on at least one part to be used to manufacture a product. The apparatus includes a part-data creating unit configure to create part data that includes information on a part designated by a customer to be used to manufacture a product; a common-function-part data creating unit configured to create common-function-part data that includes at least two common-function-parts that have substantially common functions and priority information of each of the common-function-parts; an acquiring unit configured to acquire replacement-possibility data indicative of whether replacement of designated part with an alternative part is possible; an extracting unit configured to extract an alternative part for the designated part based on the common-function-part data; a determining unit configured to determine whether to replace the designated part with the alternative part based on the common-function-part data and the replacement-possibility data.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a system according to an embodiment of the present invention;

FIG. 2 is a schematic for illustrating data in a common-part-data storage unit;

FIG. 3 is a schematic for illustrating data in a knowledge-data storage unit;

FIG. 4 is a schematic for illustrating data in an order-data storage unit;

FIG. 5 is a flowchart of a new registration process according to the embodiment;

FIG. 6 is a flowchart of a part-table-validity checking process according to the embodiment;

FIG. 7 is a flowchart of a part-information search process according to the embodiment;

FIG. 8 is a flowchart of a replacement checking process according to the embodiment;

FIG. 9 is a flowchart of a proposal creating process according to the embodiment;

FIG. 10 is a flowchart of a replacement consideration process according to the embodiment;

FIG. 11 is a flowchart of a consideration-result registration process according to the embodiment;

FIG. 12 is a flowchart of an alteration registration process according to the embodiment;

FIG. 13 is a flowchart of an alteration output process for a part list according to the embodiment;

FIG. 14 is a flowchart of an alteration output process for a common-part list according to the embodiment;

FIG. 15 is a schematic of a display screen;

FIG. 16 is a schematic of another display screen; and

FIG. 17 is a schematic of still another display screen.

### DETAILED DESCRIPTION OF THE PREFERRED EMBODIMENTS

Exemplary embodiments according to the present invention will be explained below with reference to the accompanying drawings. It is assumed that a customer places an order with a contract company for manufacturing printed boards on which a circuit arrangement designed by the customer is to be mounted. In this embodiment, a part-information management method and a part-information management program for providing a product or a printed board at a lower cost within a short delivery time by replacing a part designated in the circuit arrangement designed by the customer by a part having a higher cost performance, a part having a more stable quality, a part more commercially available or the like will be explained.

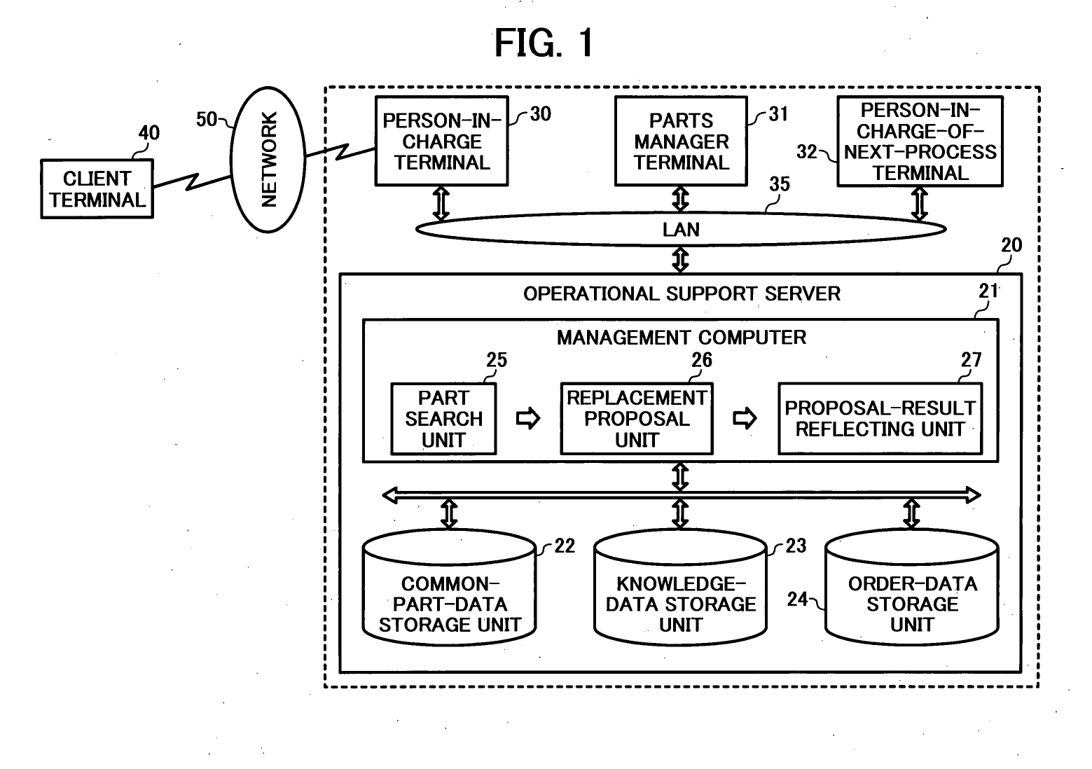

As shown in FIG. 1, a system for an operation of receiving an order for manufacturing printed boards from a customer and of performing a contract manufacturing includes an operational support server 20. This operational support server 20 is connected to a person-in-charge terminal 30, a parts manager terminal 31, and a person-in-charge-of-next-process terminal 32 through a local area network (LAN) 35. The person-in-charge terminal 30 is connected to a customer terminal 40 through a network 50.

As shown in FIG. 1, this operational support server 20 includes a management computer 21. The management computer 21 includes a control unit (central processing unit (CPU)), a storage unit (a random access memory (RAM), a read-only memory (ROM), a hard disk), a communication unit (not shown). The management computer 21 performs processes including a part search stage, a replacement proposal stage, a replacement proposal result reflecting stage. By executing a part-information management program for executing the processes, the management computer 21 functions as a part search unit 25, a replacement proposal unit 26, a proposal-result reflecting unit 27. The part search unit 25 searches a common-part-data storage unit 22 for a customer designated part in part table data recorded in an order-data storage unit 24, and extracts data on a possible replacement common part. If a priority order of the customer designated part is lower than that of the extracted common part, the replacement proposal unit 26 acquires information on possibility of replacement of this customer designated part for the customer based on a knowledge-data storage unit 23. If the replacement proposal is possible, the replacement proposal unit 26 generates a replacement proposal based on the data on the replacement common part, and provides the generated replacement proposal to the customer. The proposal-result reflecting unit 27 updates the part table data recorded in the order-data storage unit 24 based on a customer reply to the replacement proposal. In addition, the proposal-result reflecting unit 27 records the data on the alternative part thus proposed and on the customer reply in the knowledge-data storage unit 23 for every customer.

The operational support server 20 includes the common-part-data storage unit 23 that stores common part data, the knowledge-data storage unit 23 that stores knowledge data, and the order-data storage unit 24 that stores order data.

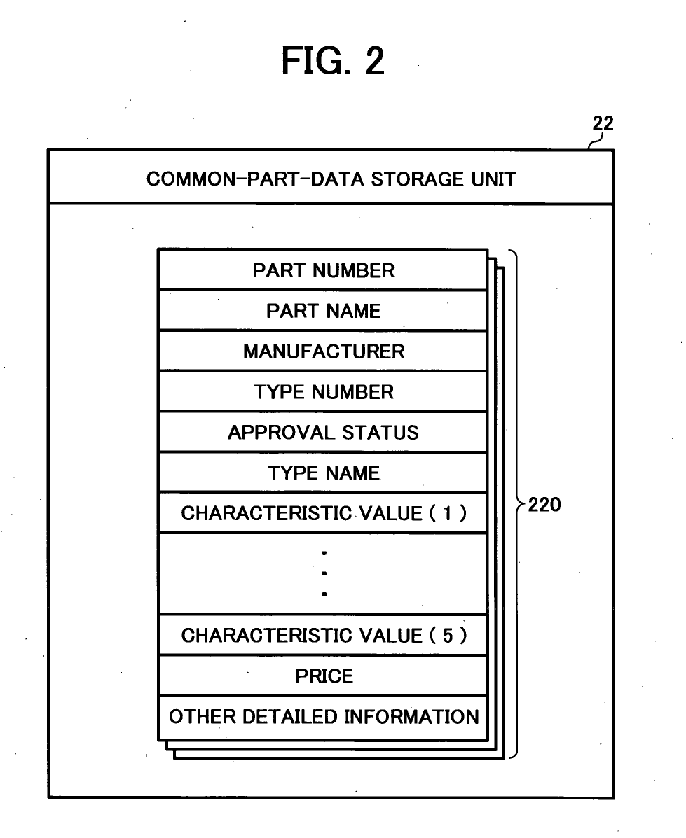

As shown in FIG. 2, the common-part-data storage unit 22 records common part data 220 on a common part used in common in the contract company for each part number. This common part data 220 is recorded in the unit 22 if a part is registered as a common part. The common part data 220 includes data on a part number, a part name, a manufacturer name, a type number, an approval status, a type name, characteristic values (1) to (5), and other detailed information for each part number.

In an area of the part number data, data on the part number for specifying the common part by an in-company system is recorded. In an area of the part name data, data on the part name for specifying the common part is recorded. In an area of the manufacturer name data, data on the manufacturer name of a manufacturer of this common part is recorded. In an area of the approval status data, data on the approval status of this common part is recorded. Specifically, in the approval status data area, status information is recorded. The status includes “recommended”, “approved”, “unchecked”, “unrecommended”, “restricted”, “prohibited”, “discontinued”, “disapproved”, or the like. “Recommended” indicates that the common part is approved and positively recommended to be used. “Approved” indicates that use of the common part is approved. In this embodiment, replacement of the customer designated part by a “recommended” or an “approved” alternative part is proposed. If the customer designated part is “approved” part and the “recommended” common part is present, replacement of the customer designated part by this “recommended” common part is proposed. In an area of the type name data, data on the type name of this common part is recorded. In an area of the characteristic value data, data on characteristic values is recorded. In this embodiment, the data on one to five characteristic values are recorded. For example, specifically, in the characteristic value data area, an electrostatic capacity, a tolerance, a rated voltage, and the like are recorded. In an area of the other detailed information data, data on the other detailed information such as revision of the part, production discontinuation or the like is recorded.

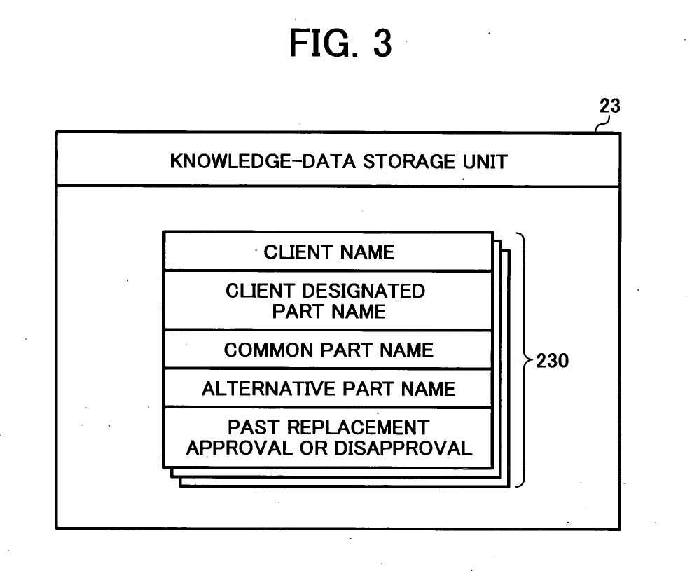

As shown in FIG. 3, the knowledge-data storage unit 23 records knowledge data 230 on a past customer approval or disapproval of use of an alternative part for every customer reply to the replacement proposal in regard of each part. The knowledge data 230 is recorded if, for example, the customer reply to the replacement proposal is obtained from the customer. The knowledge data 230 includes data on a customer name, a customer designated part name, a common part name, an alternative part name, and a past approval or disapproval of replacement.

In an area of the customer name data, data on the customer name, a customer code, and the like for specifying the customer is recorded. In an area of the customer designated part data, data on the customer designated part name, the customer designated part number, and the like is recorded. In an area of the common part name data, data on a common part name, a common part number, and the like corresponding to the customer designated part and recorded in the common-part-data storage unit 22 is recorded. In an area of the alternative part name data, data on the proposed alternative part name, and the proposed alternative part number of the alternative part proposed to replace the customer designated part and recorded in the common-part-data storage unit 22 is recorded. In an area of the past replacement approval or disapproval data, data on “approval” or “disapproval” as the customer reply to the replacement proposal for the alternative part is recorded.

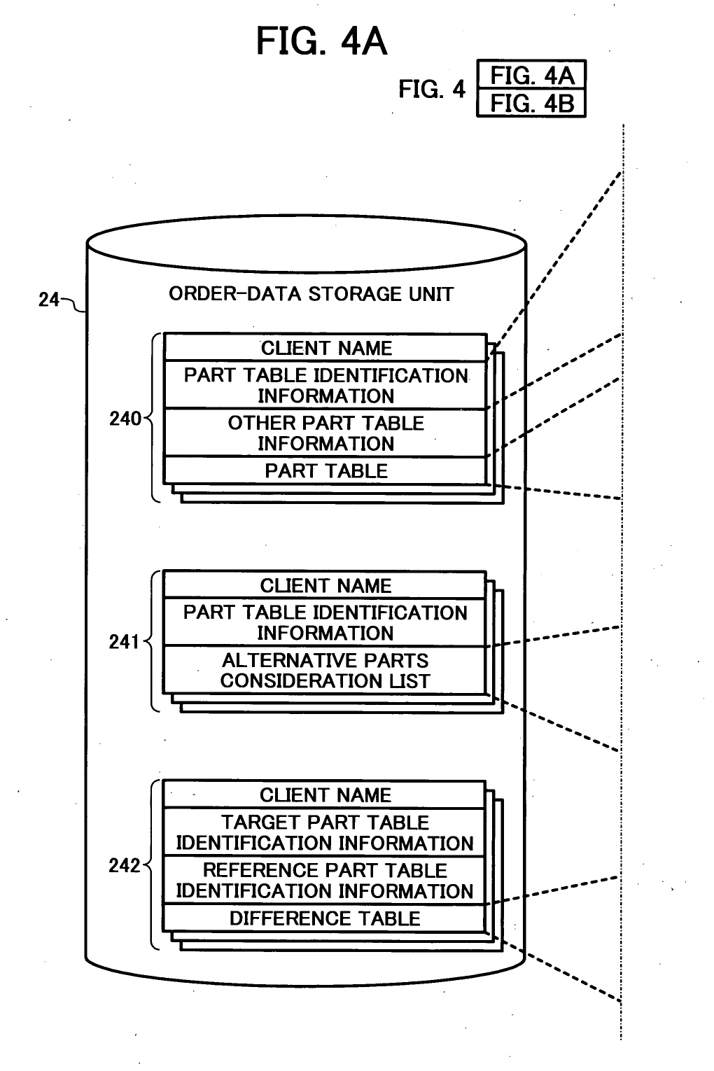

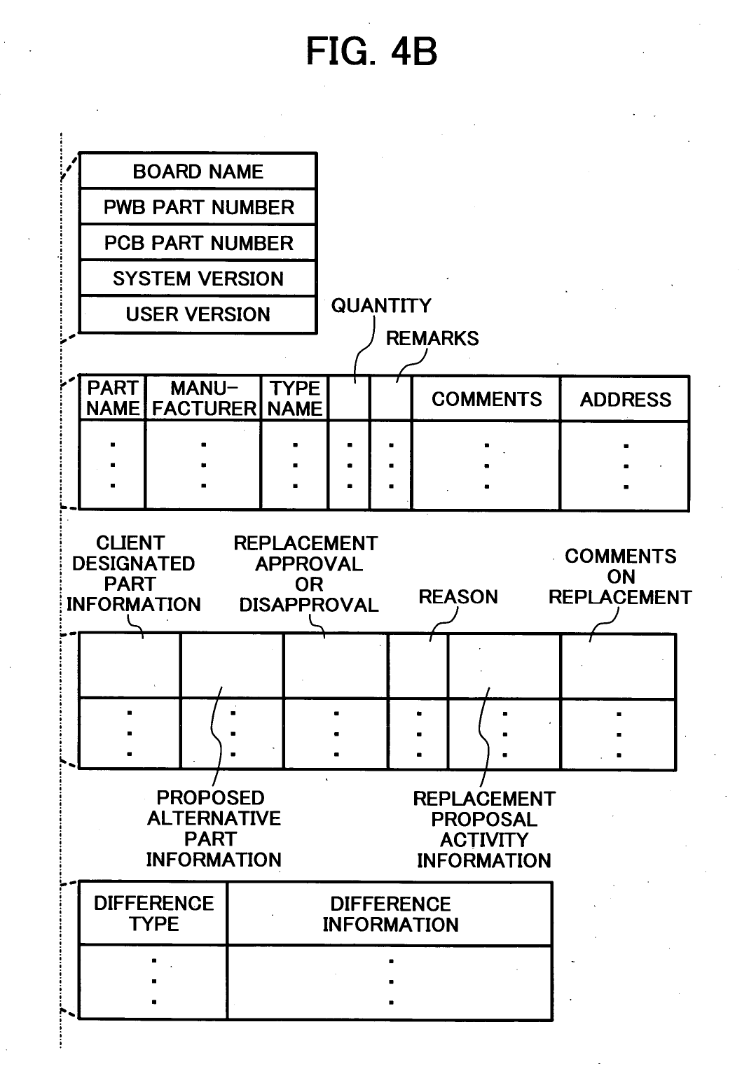

As shown in FIG. 4, the order-data storage unit 24 records order data 240, replacement consideration data 241, and difference data 242.

The order data 240 is recorded based on input order information if the contract company accepts the order for manufacturing printed boards from the customer. The order data 240 includes data on a customer name, part table identification information, other part table information, and a part table. The part table identification information includes data on a board name, a printed wiring board (PWB) part name, a printed circuit board (PCB) part name, a system version, and a user version. The part table includes data on a part name, a manufacturer name, a type name, quantity, remarks, comments on part, and address, for each part.

In an area of the customer name data, data on the customer name, a customer code, and the like for specifying the customer is recorded. In an area of the board name data, data on the board name, a part number, and the like is recorded. In an area of the PWB part number data, data on the part number of a PWB is recorded. In an area of the PCB part number data, data on the part number of a PCB is recorded. In an area of the system version data, data on the system version is recorded. In an area of the user version data, data on the user version is recorded. In an area of the other part table information, data on a release date, an operator name, and comments is recorded.

In an area of the part table data, data on the part name, the manufacturer name, the type name, the quantity, the remarks, the comments, and the address is recorded for each part. In an area of the part name data among the part table data, data on the part name, the part number, and the like for specifying each part is recorded. In an area of the manufacturer name data, data on the manufacturer name, and a manufacturer code for specifying the manufacturer of the part is recorded. In an area of the type name data, data on the type name of this part is recorded. In an area of the quantity data, data on the number of parts of this type used to manufacture the board is recorded. In an area of the remarks data, data on information necessary as comments is recorded. In an area of comments on part data, data of comments on the part is recorded.

In this embodiment, the address information is used to specify a position of each part on the board. In an area of the address information data, information on an address of the part for specifying the part and detailed information on the part at this address are recorded. For example, if three parts of the same type specified by the same part name are used, “3” is recorded in the area of the quantity data and the address information on three addresses is recorded in the address information data area. As the detailed information, information on a non-mounting flag for identifying whether or not the part is mounted on the board, and a trial or special part is recorded.

The replacement consideration data 241 is recorded based on a common part search result if the replacement proposal for the alternative part is made. The replacement consideration data 241 includes data on the customer name, the part table identification information, and an alternative part consideration list. The alternative part consideration list is constituted by alternative-part consideration data on each part.

In an area of the customer name data, data on the customer name, and the customer code for specifying the customer is recorded. In an area of the part table identification information, data on identification information for specifying the part table is recorded. Specifically, in the area of the part table identification information data, data on the board name, the PWB part name, the PCB part name, the system version, and the user version is recorded. In an area of the alternative part consideration list data, data on customer designated part information, proposed alternative part information, an approval or a disapproval of replacement, a reason, replacement-proposal-activity information, and comments on replacement is recorded. In an area of the customer designated part information data among the alternative-part consideration data, data on the part name, the manufacturer name, and the type name for specifying the customer designated part is recorded. In an area of the proposed alternative part information data, data on a common part number, a common part name, a manufacturer name, an approval status, characteristic values (1) to (5), a price, and other detailed information of a common part searched as a part replacing the part designated by the customer (customer designated part) is recorded.

The difference data 242 is data on a difference between a part table included in change data and a part table one version before the part table in the change data. The difference data 242 is recorded if the change data is received from the customer terminal 40. The difference data 242 includes data on the customer name, target-part-table identification information, reference-part table-identification information, and a difference table. The difference table is configured by different part data on a part for which the difference is generated.

In an area of the customer name data, data on the customer name and the customer code for specifying the customer is recorded. In an area of the target-part-table identification information data, data on identification information for specifying a target part table based on the part table included in the change data is recorded. Specifically, in the area of the target-part-table identification information data, data on the board name, the PWB part number, the PCB part number, the system version, and the user version is recorded. In an area of the reference-part table-identification information data, data on identification information for specifying a reference part table that is the part table one version before the part table included in the change data is recorded. Specifically, in the area of the reference-part table-identification information data, data on the board name, the PWB part name, the PCB part name, the system version, and the user version is recorded.

In an area of the different part data, data on a different type name and difference information corresponding to this different type is recorded. In an area of the different type data among the different part data, data on the different type name is recorded. Specifically, in the area of the different type data, data as to addition of a not-mounted part, and addition of a mounted part is recorded. In an area of data on each part corresponding to each different type, data on detailed information on each part corresponding to the different type is recorded.

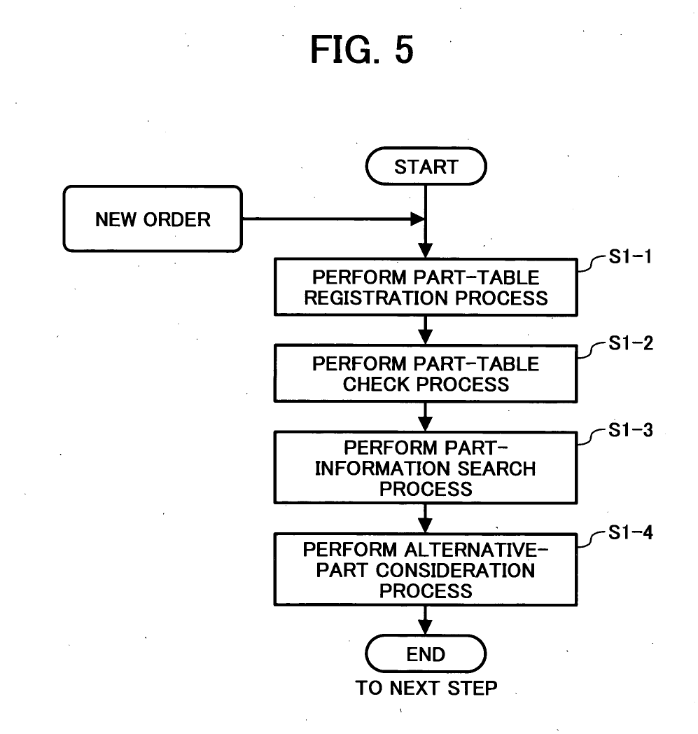

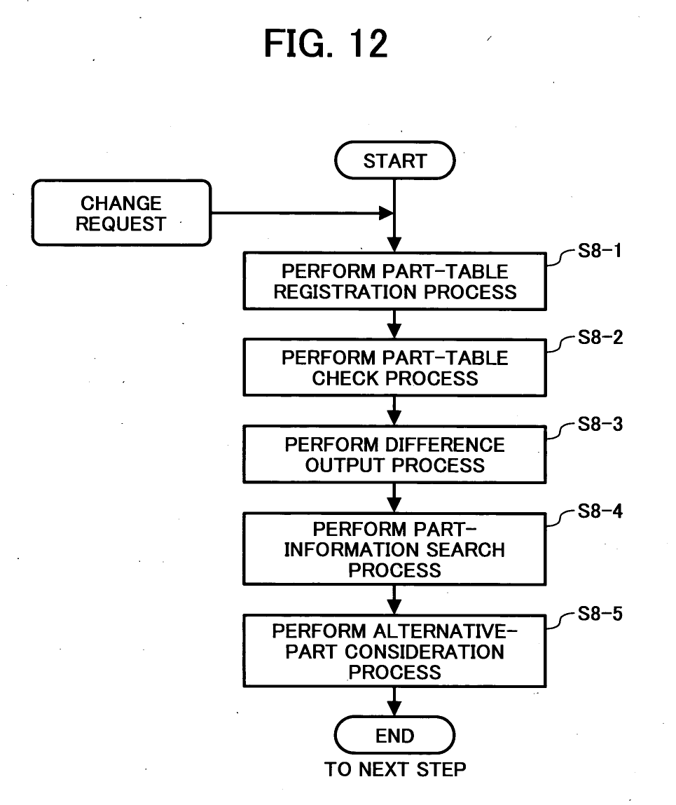

In this embodiment, the process procedure is explained separately for a new registration process (FIG. 5), a change registration process (FIG. 12), and a process by changing common part registration.

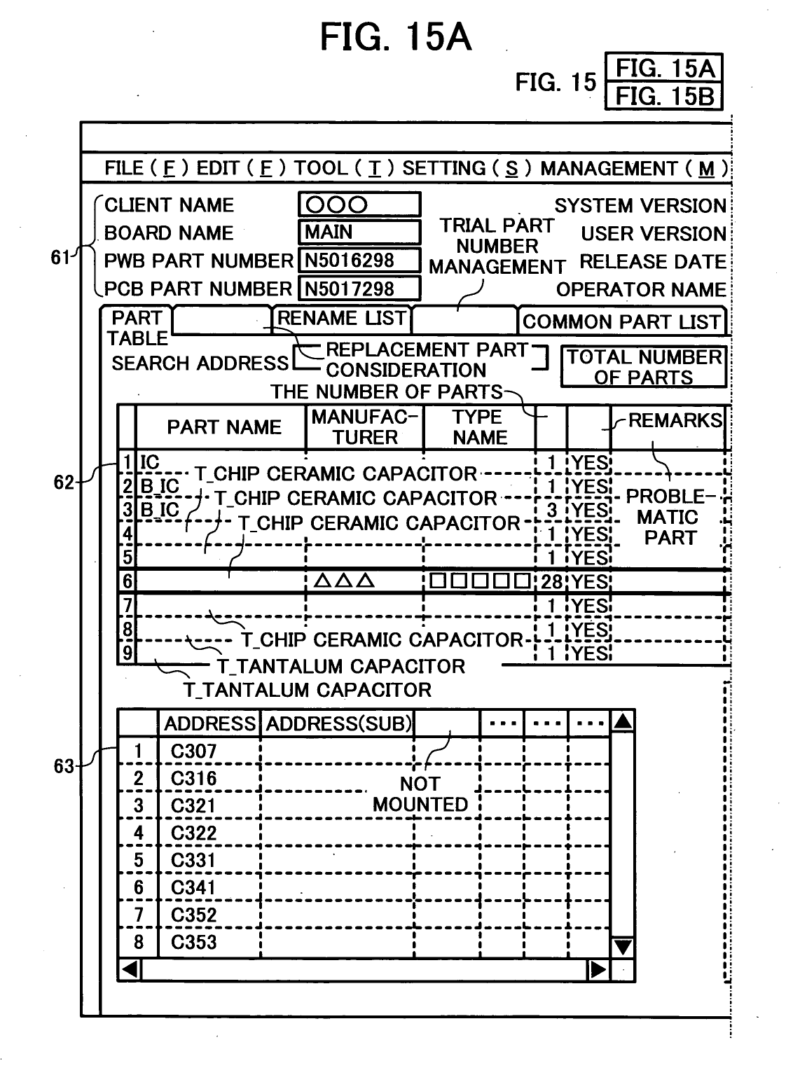

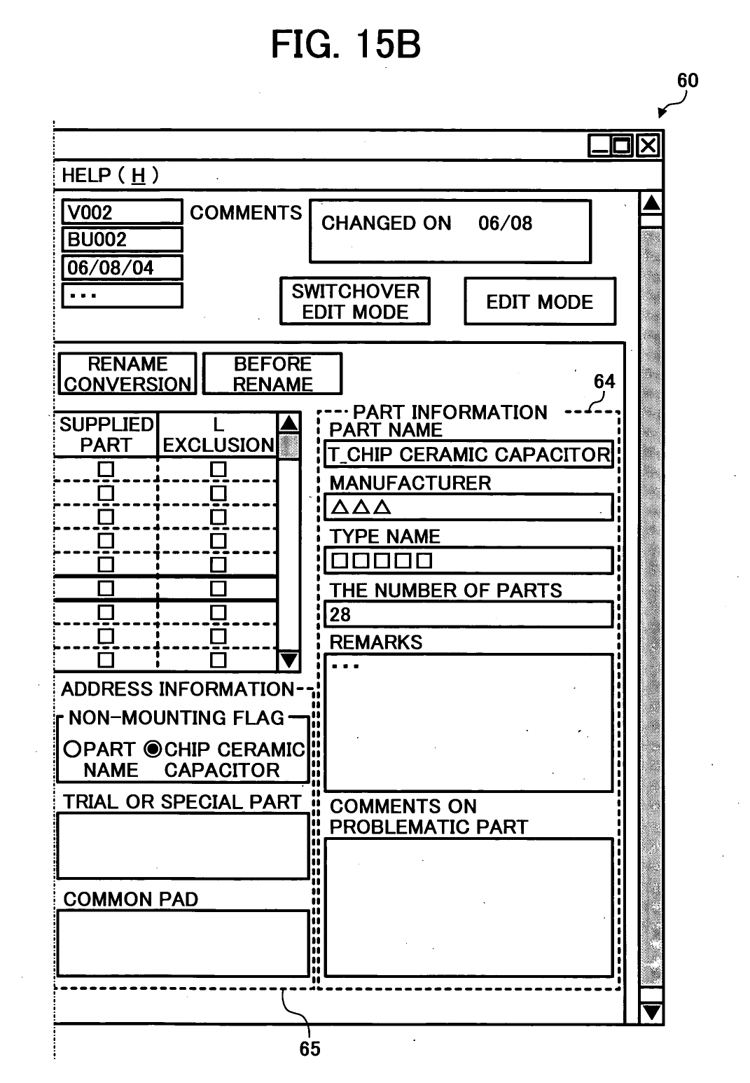

The customer that places a new order for manufacturing printed boards transmits new order data including the part table in a tabular format to the person-in-charge terminal 30. The part table in this new order data includes data on the part name, the manufacturer name, the type name, the number of parts, the remarks, the comments on part, and the address information for each part. The person in charge that accepts the manufacturing order inputs order information using the person-in-charge terminal 30 based on this new order data. As shown in FIG. 5, the management computer 21 of the operational support server 20 performs a part-table registration process based on the input data (at step S1-1). Specifically, the order data 240 including the part table in the new order data is recorded. As shown in FIG. 15, a part table screen 60 including a registered part table is displayed on a display of the person-in-charge terminal 30.

As shown in FIG. 15, the part table screen 60 includes an order identification information display area 61, a customer part list table 62, an address information list table 63, a part information display area 64, and an address information display area 65. In the order identification information display area 61, the customer name, the board name, the PWB part number, the PCB part number, the system version, the user version, the release date, the operator name, and the comments are displayed based on the order identification data included in the order data 240. In the customer part list table 62, the part table is displayed based on parts of the part table data included in the order data 240 except for the address information. In the address information list table 63, the address information on selected parts in the customer part list table 62 is displayed based on the address information on the selected parts in the part table data included in the order data 240. In the part information display area 64, information on the selected parts in the customer part list table 62 is displayed. This information is displayed based on the order part data on the selected parts in the part table data included in the order data 240. In the address information display area 65, address information on addresses of the selected parts in the address information list table 63 is displayed. This information is displayed based on the address information on the selected parts in the part table data included in the order data 240.

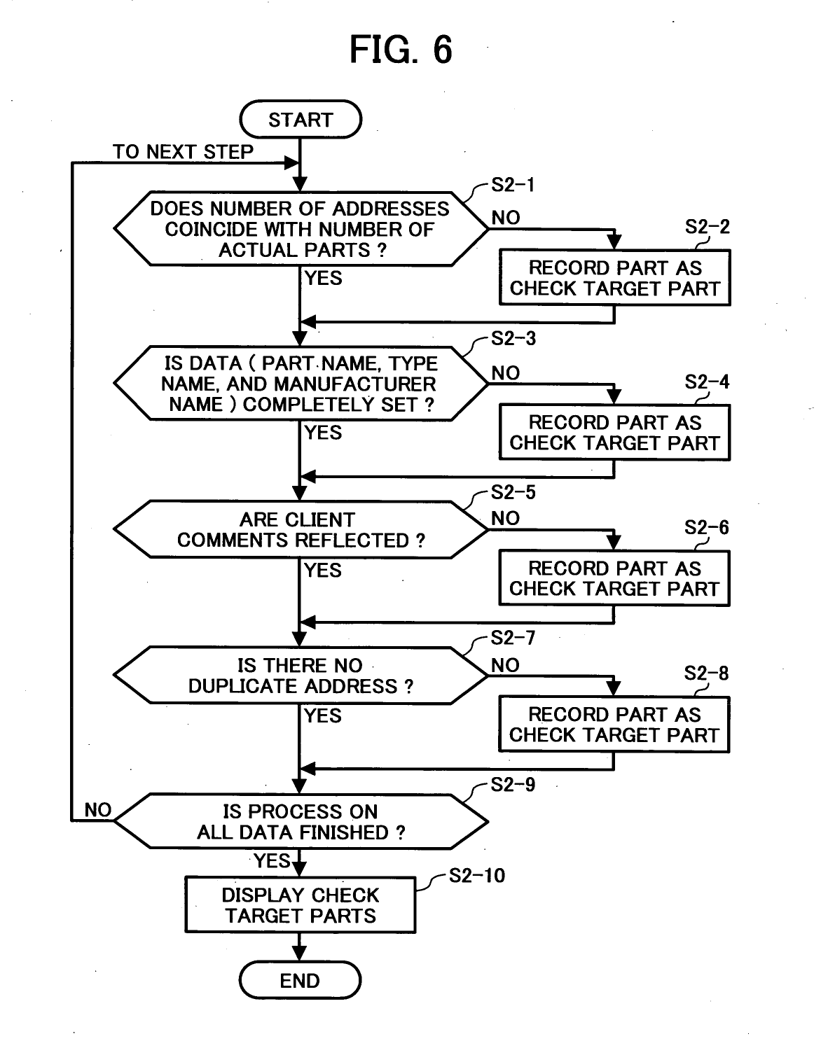

The management computer 21 performs a part-table check process (at step S1-2). Specifically, the person in charge inputs a part-table check process execution request for the registered part table to the management computer 21 using the person-in-charge terminal 30. The management computer 21 executes a part table-validity check process shown in FIG. 6 in response to the request.

As shown in FIG. 6, the management computer 21 checks whether the number of addresses coincides with the number of actual parts for first order part data in the part table data included in the order data 240 (at step S2-1). The management computer 21 calculates first the number of addresses in the address information data area in the first order part data. The management computer 21 then compares the calculated number of addresses with the number of parts (the number of actual parts) included in the order part data. If they do not coincide (“NO” at step S2-1), the management computer 21 records the part in the storage unit within the management computer 21 as a check target part (at step S2-2) and moves the process to step S2-3. If they coincide (“YES” at step S2-1), the management computer 21 moves the process directly to step S2-3.

The management computer 21 checks whether data on the part name, the type name, the manufacturer name, and the like is completely set for this first order part data (at step S2-3). Specifically, the management computer 21 determines whether the data on the part name, the type name, and the manufacturer name is set in the order part data. If the data is not completely set (“NO” at step S2-3), the management computer 21 records the part in the storage unit within the management computer 21 as a check target part (at step S2-4) and moves the process to step S2-5. If the data is completely set (“YES” at step S2-3), the management computer 21 moves the process directly to step S2-5.

The management computer 21 checks whether customer comments reflect in this order part data (at step S2-5). Specifically, the management computer 21 compares data on the customer comments included in the order data 240 with the data recorded in the order part data. If the customer comments do not reflect in the order part data (“NO” at step S2-5), the management computer 21 records the part in the storage unit within the management computer 21 as a check target part (at step S2-6) and moves the process to step S2-7. If the customer comments reflect in the order part data (“YES” at step S2-5), the management computer 21 moves the process directly to step S2-7.

The management computer 21 checks whether there is no duplicate address for this order part data (at step S2-7). Specifically, the management computer 21 determines whether the address information recorded in the address information data area of this part data is redundantly recorded in the part table. If the duplicate address is present (“NO” at step S2-7), the management computer 21 records the part in the storage unit within the management computer 21 as a check target part (at step S2-8) and moves the process to step S2-9. If there is no duplicate address (“YES” at step S2-7), the management computer 21 moves the process directly to step S2-9.

If order part data that is not subjected to the part table-validity check process yet remains in the part table data (“NO” at step S2-9), the management computer 21 returns the process to step S2-1 and performs the part table-validity check process on next order part data included in the part table data. The management computer 21 repeats the part table-validity check process from steps S2-1 to S2-9 until all the order part data is subjected to the process.

If the process on all the order part data is finished (“YES” at step S2-9), the management computer 21 displays the recorded check target parts on the person-in-charge terminal 30 (at step S2-10).

The person in charge corrects the part table based on information on the check target parts displayed on this person-in-charge terminal 30. Upon finishing correction, the person in charge inputs a part-table check process execution request again. The management computer 21 re-executes the part table-validity check process shown in FIG. 69 in response to the request. The management computer 21 finishes the part-table check process when no check target part is displayed in relation to this part table-validity check process.

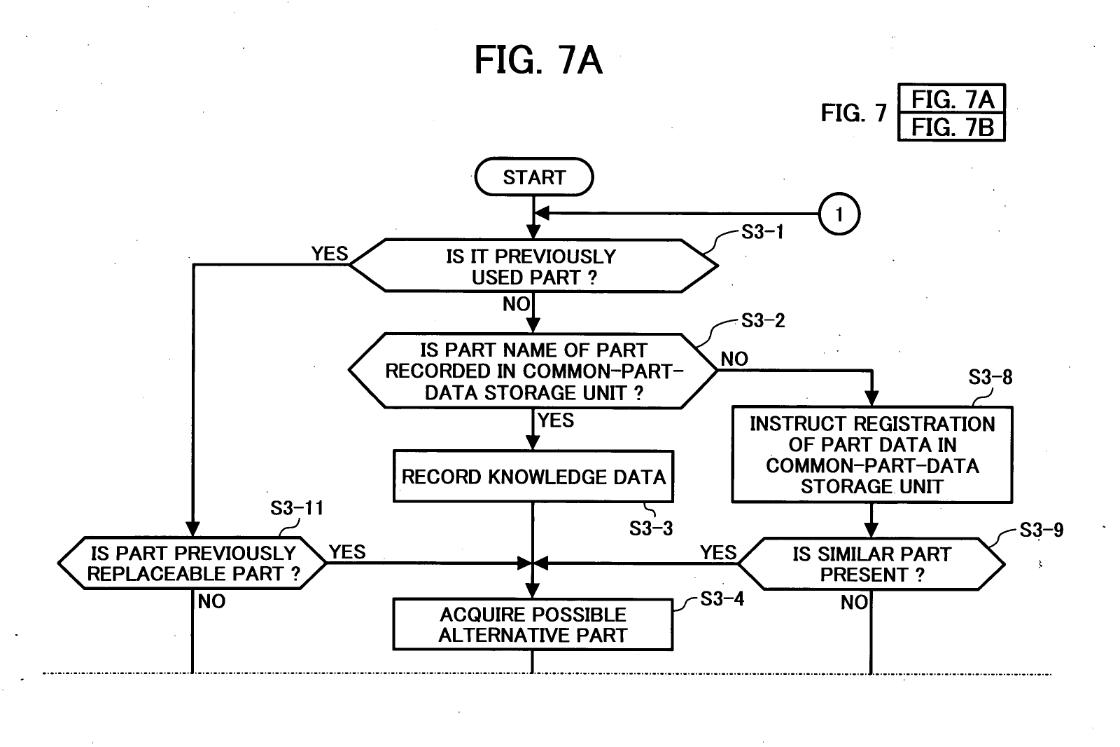

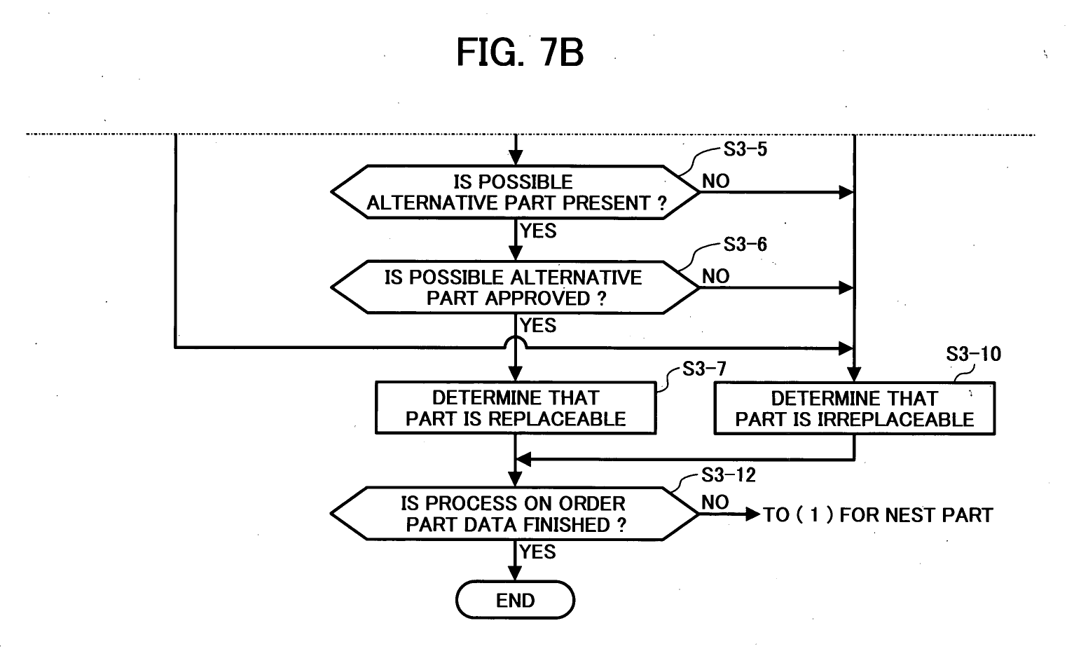

Thereafter, the management computer 21 performs a part-information search process (at step S1-3). Specifically, when the part-table check process is finished, the person in charge inputs a part information search request to the management computer 21 using the person-in-charge terminal 30. The management computer 21 executes the part-information search process shown in FIG. 7 in response to the request.

Specifically, as shown in FIG. 7, the management computer 21 checks-first whether the first order part data in the part table data is a previously used part (at step S3-1). Specifically, the management computer 21 searches the customer name, and the customer designated part name in the knowledge-data storage unit 23 based on the part identifiable information such as the customer name, the part name, and the part number in the order part data included in the order data 240. If the knowledge data 230 on the corresponding customer name and customer designate part name is recorded in the knowledge-data storage unit 23, the part is the previously used part. If the part is not the previously used part (“NO” at step S3-1), the management computer 21 checks whether the part name of this customer designated part is recorded in the common-part-data storage unit 22 (at step S3-2). Specifically, the management computer 21 searches the common data storage unit 22 using the part identifiable information such as the part name and the part number in the order part data, and extracts the searched common part data 220.

If the part name of this customer designated part is recorded in the common-part-data storage unit 22 (“YES” at step S3-2), the management computer 21 records the knowledge data 230 in which the customer designated part name and the common part name are set (at step S3-3). Specifically, the management computer 21 records the part name in the order part data as the customer designated part name and the part name in the common part data 220 as the common part name.

The management computer 21 acquires data on the possible alternative part (at step S3-4). Specifically, the management computer 21 searches the common-part-data storage unit 22 based on the type name, the characteristic values, and the price of the common part data 22 searched based on the part name in the order part data. In this embodiment, the management computer 21 searches the common-part-data storage unit 22 for the possible alternative part of the same part name, equal or greater characteristic values, and an equal or a lower price. In addition, the management computer 21 extracts the possible alternative part having an approval status equal to or higher than that of the common part data 220 corresponding to the order part data.

If the possible alternative part is present (“YES” at step S3-5), the management computer 21 checks whether the part extracted as the possible alternative part is approved (at step S3-6). Specifically, if the approval status of the extracted possible alternative part is “approved” or “recommended”, this indicates that the possible alternative part is approved.

If the possible alternative part is approved (“YES” at step S3-6), the management computer 21 determines that the part of this order part data is replaceable (at step S3-7). In this case, the management computer 21 records alternative-part consideration data, in which the customer designated part information, the proposed alternative part information, and “approval” as the replacement approval or disapproval are set, while associating the alternative-part consideration data with the customer name and the part table identification information included in the replacement consideration data 241. If the part name (customer designated part name), the manufacturer name, and the type name in the order part data as well as the corresponding common part data 220 are present, the customer designated part information includes the part name (common part type name) in this common part data 220. In addition, the proposed alternative part information includes the part number, the part name (alternative part name), the manufacturer name, the approval status, the characteristic values (1) to (5), the price, and the other detailed information in the common part data 220 on the common part.

If no possible alternative part is present (“NO” at step S3-5), the management computer 21 determines that the part of this order part data is irreplaceable (at step S3-10). In this case, the management computer 21 records the alternative-part consideration data, in which the customer designated part information and “disapproval” as the replacement approval or disapproval are set, while associating the alternative-part consideration data with the customer name and the part table identification information in the replacement consideration data 241. If the part of the order part data is recorded in the common-part-data storage unit 22 and the approval status of the part is “recommended”, this part is used and not replaced by the alternative part. In this case, similarly to the above, the management computer 21 determines that no possible alternative part is present and that this part is irreplaceable. In this case, the management computer 21 records the alternative-part consideration data, in which the customer designated part information and “replacement unnecessary” as the replacement approval or disapproval are set, while associating the alternative-part consideration data with the customer name and the part table identification information in the replacement consideration data 241.

If the part of the common part data 220 extracted as the possible alternative part is not approved (“NO” at step S3-6), the management computer 21 determines that the part of this order part data is irreplaceable (at step S3-10). The management computer 21 records the replacement consideration data, in which the customer designated part information, the proposed alternative part information, and a replacement disapproval flag which means that replacement is “disapproved” are set, while associating the alternative-part consideration data with the customer name and the part table identification information in the replacement consideration data 241.

If the part name in the order part data is not recorded in the common-part-data storage unit 22 (“NO” at step S3-2), the management computer indicates registration of the part data in the common-part-data storage unit 22 (at step S3-8). Specifically, the management computer 21 designates the part name on the display of the person-in-charge terminal 30 to display a part registration indication thereon. The person in charge designates the part name of this part and transmits a part registration request to a parts manager based on this indication. The parts manager acquires information on this part based on the part name designated by the person in charge and registers the part in the common-part-data storage unit 22 using the parts manager terminal 31. The common part data 220 on this part is thereby recorded in the common-part-data storage unit 22.

The management computer 21 checks whether a similar part to the part of this order part data is present (at step S3-9). Specifically, the management computer 21 checks whether the common part data 220 of the same type, similar characteristic values, and a similar price to the part of the order part data is present based on the designated type name, characteristic values, and price. If such common part data 220 is recorded, this indicates that the similar part is present. If the similar part is present (“YES” at step S3-9), the management computer 21 moves the process to step S3-4. At step S3-4, the management computer 21 acquires the data on the possible alternative part based on the designated type name, characteristic values, and price for the part of this order part data.

If no similar part is present (“NO” at step S3-9), the management computer 21 determines that the part of this order part data is irreplaceable (at step S3-10). In this case, the management computer 21 records the replacement disapproval flag while associating the flag with the order part data.

If the part of the order part data is the previously used part (“YES” at step S3-1), the management computer 21 checks whether this part is a previously replaceable part (at step S3-11). Specifically, the management computer 21 searches data on previous approval or disapproval for the searched knowledge data 230 in the knowledge-data storage unit 23 based on the customer name and the part name in the order part data recorded in the order data 240. If “approval” is recorded as the past replacement approval or disapproval, this indicates that the part is the previously replaceable part. If the part is the previously replaceable part (“YES” at step S3-11), the management computer 21 moves the process to step S3-4. If the part is not the previously replaceable part (“NO” at step S3-11), the management computer 21 determines that the part is irreplaceable (at step S3-10). The management computer 21 records the replacement disapproval flag while associating the flag with the order part data.

If order part data which is not subjected to the search process yet remains in the part table data (“NO” at step S3-12), the management computer 21 returns the process to step S3-1 and performs the process on the next order part data included in the part table data. The management computer 21 repeats the process from steps S3-1 to S3-12 until all the order part data is subjected to the process. If this process on all the order part data in the part table data is finished (“YES” at step S3-12), the management computer 21 finishes the part-information search process.

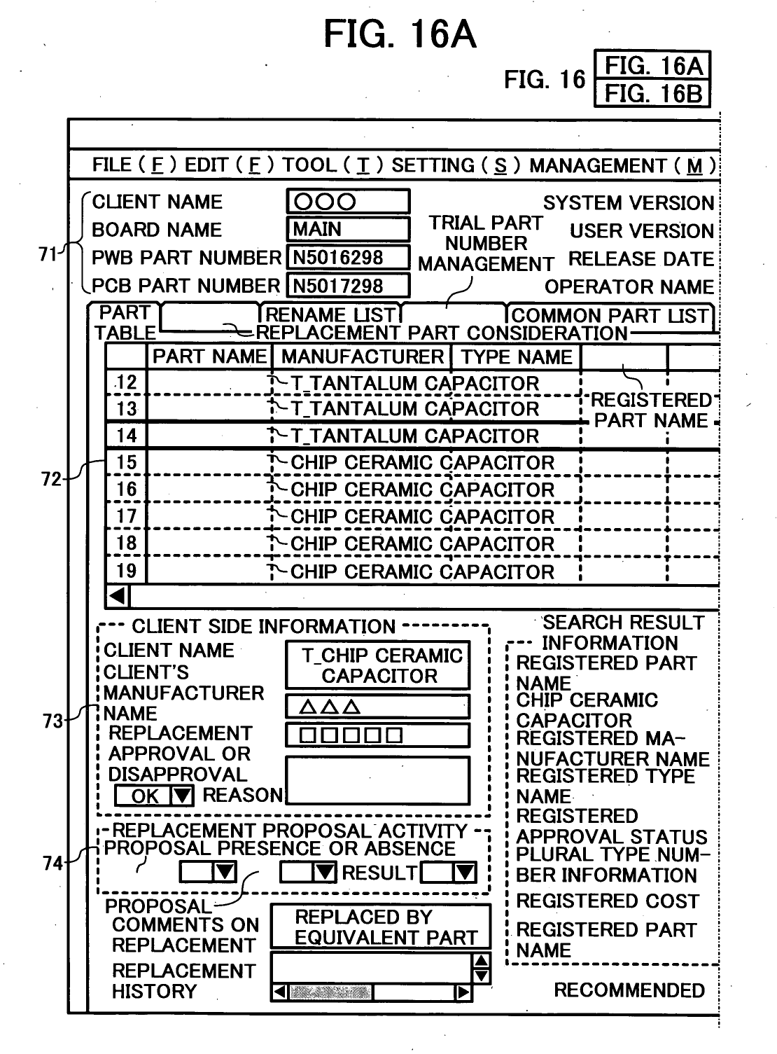

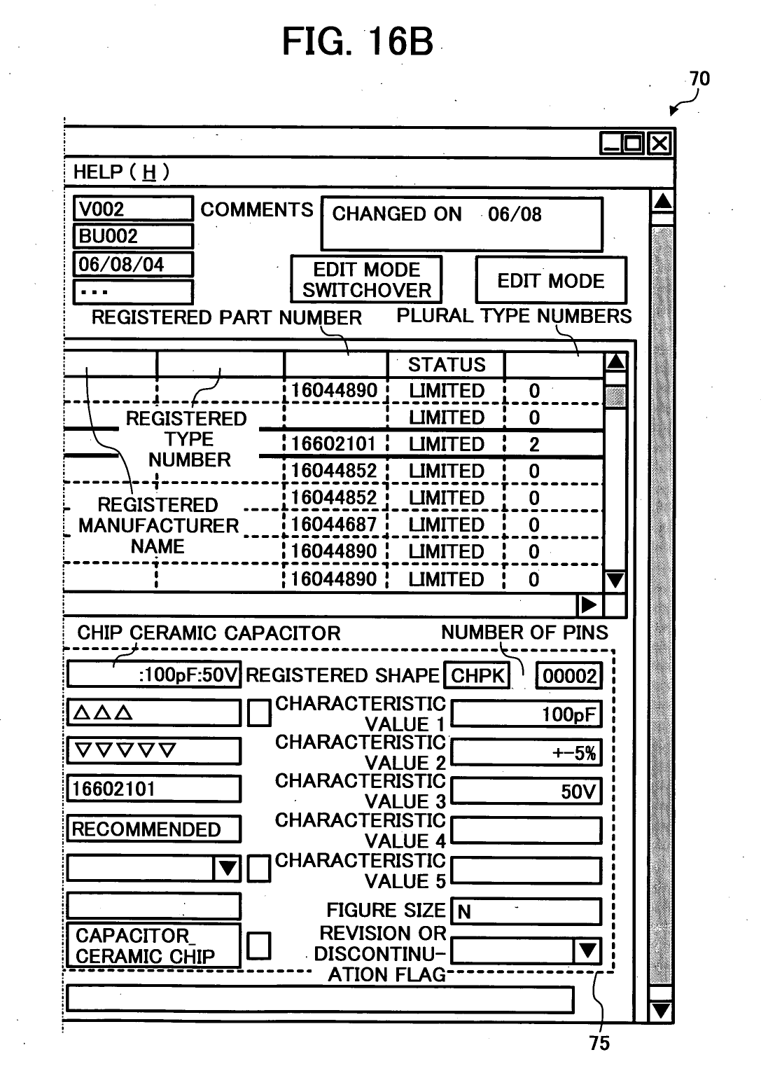

The management computer 21 then executes an alternative-part consideration process (at step S1-4). The management computer 21 displays a replacement consideration screen 70 shown in FIG. 16 on the person-in-charge terminal 30 based on the replacement consideration data 241. The person in charge considers the alternative part using this replacement consideration screen 70.

As shown in FIG. 16, the replacement consideration screen 70 includes an order identification information display area 71, a part list table 72, a customer side information display area 73, a replacement proposal activity display area 74, an alternative part search information display area 75, and the like. In the order identification information display area 71, the customer name, the board name, the PWB part number, the PCB part number, the system version, the user version, the release date, the operator name, and the comments are displayed based on the order identification data included in the order data 240. In the part list table 72, the parts in the part table data and information on common parts corresponding to the parts are displayed based on each alternative-part consideration data included in the replacement consideration data 241. In the customer side information display area 73, information on the designated parts in the part list table 72 is displayed. This information is displayed based on the customer designated part information in the alternative-part consideration data specified by the part name included in the customer designated part information in the replacement consideration data 241. In the replacement proposal activity area 74, information on a replacement proposal activity is displayed. This information is displayed based on the replacement-proposal-activity information in the alternative-part consideration data. In the alternative part search information area 75, information on the searched common data for each designated part in the part list table 72 is displayed. This information is displayed based on the proposed alternative part information included in this alternative-part consideration data.

The person in charge considers whether to make a replacement proposal for this part while referring to the replacement approval or disapproval in the customer side information display area 73 and the approval status in the alternative part search information display area 75. The person in charge inputs whether to make the replacement proposal in an input section of proposal presence or absence in the replacement proposal activity display area 74. Information as to whether the replacement proposal is present is thereby recorded in the replacement-proposal-activity information included in the proposed alternative part data.

The management computer 21 then executes a replacement consideration check process for rechecking a replacement consideration result input by the person in charge.

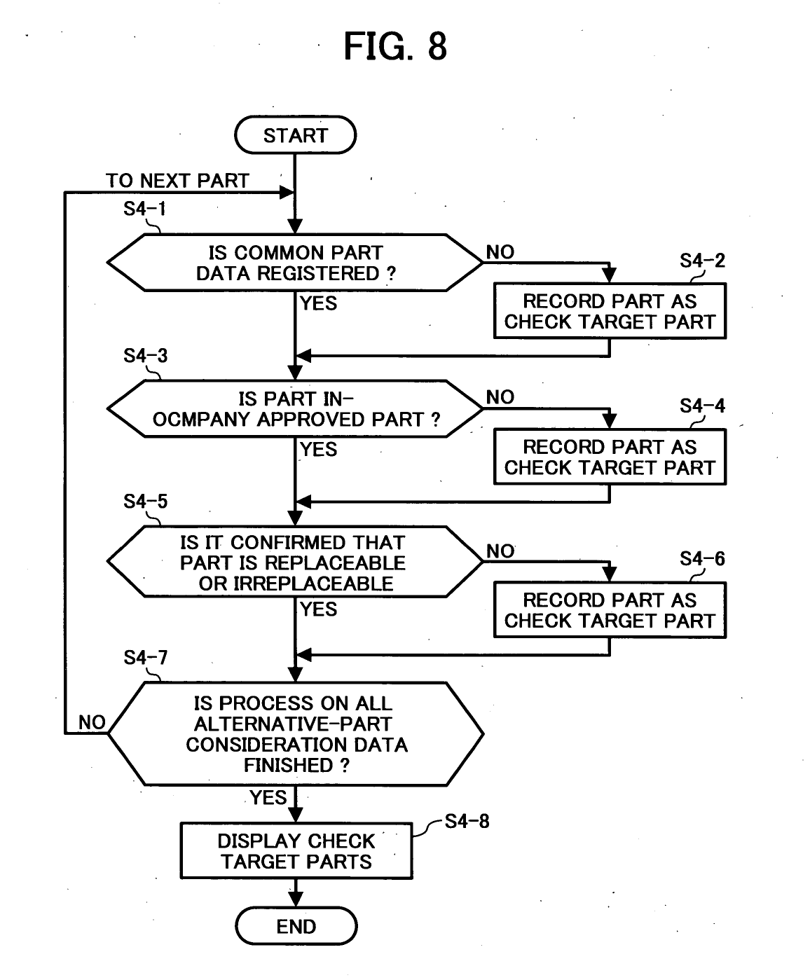

As shown in FIG. 8, the management computer 21 checks whether common part data is registered for the proposed alternative part information in the first alternative-part consideration data included in the replacement consideration data 241 (at step S4-1). Specifically, the management computer 21 searches the common-part-data storage unit 22 based on the part name and the type name in the proposed alternative part information. If the common part data 220 is not registered for this part name and this type name (“NO” at step S4-1), the management computer 21 records the part name, the type name, and “no common part number is present” as check information in the storage unit of the management computer 21 as the data of a check target part (at step S4-2). The management computer 21 then moves the process to step S4-3. If the common part data 220 is registered (“YES” at step S4-1), the management computer 21 moves the process directly to step S4-3.

The management computer 21 checks whether the common part is an in-company approved part for the part name in the proposed alternative part information included in the alternative-part consideration data (at step S4-3). Specifically, the management computer 21 checks the approval status for the common part data 220 searched based on the part name in the proposed alternative part information. If the approval status is “approved” or “recommended”, the common part is the in-company approved part. If the part is not the in-company approved part (“NO” at step S4-3), the management computer 21 records the part name, the type name, and “no approval” as the check information in the storage unit of the management computer 21 as the data of a check target part (at step S4-4). The management computer 21 then moves the process to step S4-5. If the part is the in-company approved part (“YES” at step S4-3), the management computer 21 moves the process directly to step S4-5.

The management computer 21 checks whether it is confirmed that the part is replaceable or irreplaceable (at step S4-5). Specifically, if the replacement approval or disapproval in the alternative part consideration data indicates “approval”, the management computer 21 determines that it is confirmed that the part is replaceable or irreplaceable. If it is not confirmed that the part is replaceable or irreplaceable (“NO” at step S4-5), the management computer 21 records the part name, the type name, and “not confirmed that part is replaceable” as the check information in the storage unit of the management computer 21 as the data of a check target part (at step S4-6). The management computer 21 then moves the process to step S4-7. If it is confirmed that the part is replaceable or irreplaceable (“YES” at step S4-5), the management computer 21 moves the process directly to step S4-7.

If alternative-part consideration data that is not subjected to the check process yet remains in the replacement consideration data 41 (“NO” at step S4-7), the management computer 21 returns the process to step S4-1 and performs the process on the next alternative-part consideration data. The management computer 21 repeats the process from steps S4-1 to S4-7 until the process on all the alternative-part consideration data is finished.

If the process on all the alternative-part consideration data is finished (“YES” at step S4-7), a replacement consideration result check screen that includes the part names, the type names, and the check information of the check target parts recorded in the storage unit within the management computer 21 is displayed on the person-in-charge terminal 31 (at step S4-8). The person in charge reconsiders the replacement using the replacement consideration screen 70 while referring to the information displayed on the replacement consideration result check screen, and inputs a replacement proposal. If the replacement consideration is finished, the management computer 21 moves the process to a replacement proposal creation process.

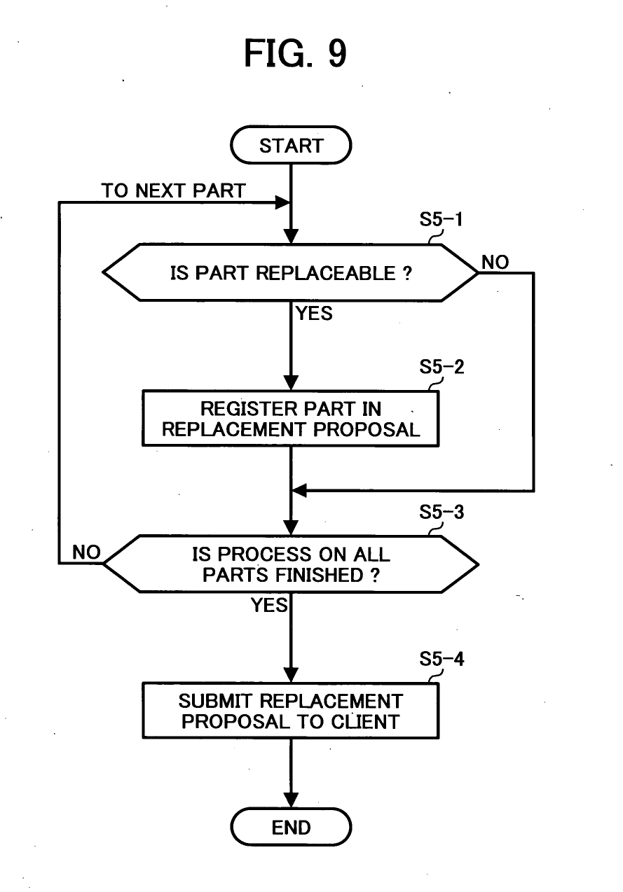

As shown in FIG. 9, the management computer 21 determines whether the part of the first alternative-part consideration data included in the replacement consideration data 241 is a replaceable part (at step S5-1). Specifically, if “replacement proposal is executed” is recorded as the replacement-proposal-activity information and the replacement approval or disapproval indicates “approval”, the management computer 21 determines that the part is a replaceable part. If the part is replaceable (“YES” at step S5-1), the management computer 21 registers the searched alternative part for this part in the replacement proposal (at step S5-2). Specifically, the management computer 21 records the customer designated part information and the proposed alternative part information included in the alternative-part consideration data in the replacement proposal data. If the part is irreplaceable (“NO” at step S5-1), the searched alternative part is not registered in the replacement proposal.

If the process is not finished on all the alternative-part consideration data (“NO” at step S5-3), the management computer 21 returns the process to step S5-1 and executes the process on the next alternative-part consideration data. The management computer 21 repeats the process from steps S5-1 to S5-3 until the process on all the alternative-part consideration data is finished (until “YES” at step S5-3).

If the process is finished on all the alternative-part consideration data (“YES” at step S5-3), the management computer 21 completes creating the replacement proposal to be submitted to the customer. The person in charge submits the replacement proposal to the customer (at step S5-4). Specifically, the management computer 21 registers the customer name in the replacement proposal data based on the customer name included in the replacement consideration data 241, and finishes creating the replacement proposal. The person in charge acquires the created replacement proposal (replacement proposal data) from the operational support server 20, attaches this replacement proposal to an electronic mail (hereinafter, “email”), and sends the proposal-attached email to the customer terminal 40.

If receiving this replacement proposal data using the customer terminal 40, the customer displays the replacement proposal based on this replacement proposal data on the customer terminal 40. In addition, the customer considers a content of the replacement proposal and determines whether to approve the replacement.

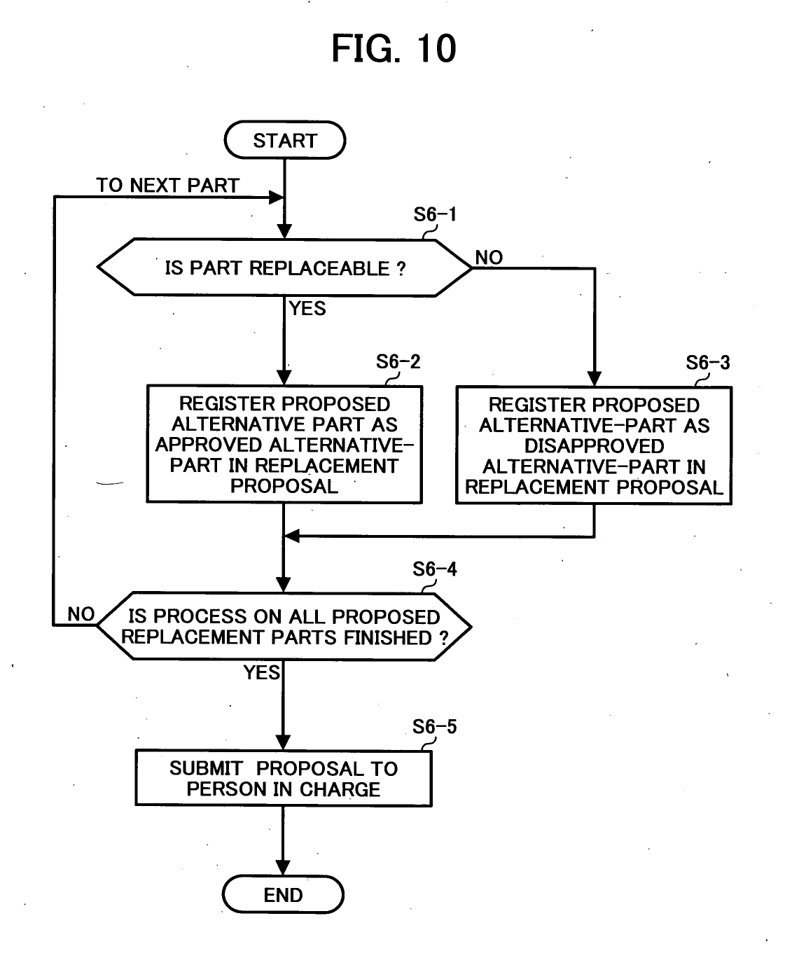

As shown in FIG. 10, if it is determined that the customer designated part is replaceable by the proposed alternative part in the replacement proposal (“YES” at step S6-1), the customer registers the proposed alternative part in the replacement proposal as an approved alternative part (at step S6-2). Specifically, the customer records “approval” in the replacement approval or disapproval input section for this customer designated part in the replacement proposal data displayed on the customer terminal 40.

If the replacement is not approved (“NO” at step S6-1), the customer registers the proposed alternative part in the replacement proposal as a disapproved alternative part (at step S6-3). Specifically, the customer records “disapproval” in the replacement approval or disapproval input section for this customer designated part in the replacement proposal data displayed on the customer terminal 40.

If the process is not finished on all proposed alternative parts (“NO” at step S6-4), the customer returns the process to step S6-1 and performs the process on the next proposed alternative part. The customer repeats the process until the process on all the proposed alternative parts is finished (until “YES” at step S6-4).

If the process on all the proposed alternative parts is finished (“YES” at step S6-4), the customer submits the replacement proposal, in which the displacement approval or disapproval is recorded, to the person in charge (at step S6-5). Specifically, the customer sends an email to which the replacement proposal, in which the displacement approval or disapproval is recorded, is attached to person-in-charge terminal 30 using the customer terminal 40.

If the person in charge receives the email to which the replacement proposal, in which the displacement approval or disapproval is recorded, is attached using the person-in-charge terminal 30, the person in charge inputs the replacement proposal data, in which the displacement approval or disapproval is recorded, to the operational support server 20 using the person-in-charge terminal 30. The management computer 21 of the operational support server 20 executes a replacement consideration result registration process using the replacement proposal data, in which the displacement approval or disapproval is recorded.

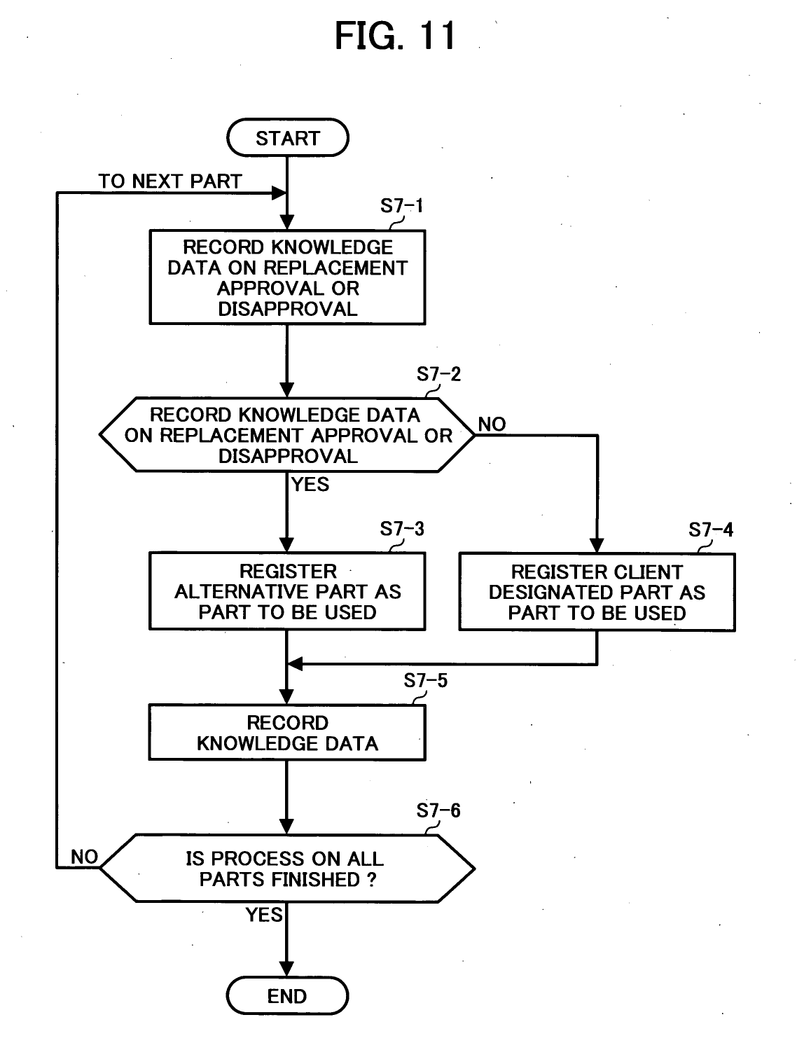

As shown in FIG. 11, the management computer 21 records the replacement approval or disapproval in the knowledge-data storage unit 23 for the replacement proposal data, in which the displacement approval or disapproval is recorded, included in the proposed alternative part data (at step S7-1). Specifically, the management computer 21 records “approval” or “disapproval” as the past replacement approval or disapproval in the knowledge-data storage unit 23 based on the data on the replacement approval or disapproval included in the proposed alternative part data. The management computer 21 then determines whether this proposed alternative part is an approved alternative part based on data on the replacement approval or disapproval recorded based on customer's input (at step S7-2). If the proposed alternative part is an approved alternative part (“YES” at step S7-2), the management computer 21 registers the alternative part as a part to be used (at step S7-3). Specifically, the management computer 21 upgrades the user version for the order data 240 specified by the customer name and the part table identification information, and edits duplicated order data 240. The management computer 21 specifies order part data in the part table data included in this order data 240 by the customer designated part name, and records the part name, the manufacturer name, and the type name of the alternative part based on the proposed alternative part data.

If the proposed alternative part is not the approved alternative part (“NO” at step S7-2), the management computer 21 registers the customer designated part as the part to be used (at step S7-4). Specifically, the management computer 21 records the order part data based on the customer designated part information included in the proposed alternative part data.

The management computer 21 records data on the part to be used in the knowledge-data storage unit 23 (at step S7-5). Specifically, the management computer 21 records the customer name, the customer designated part name, the common part name, and the alternative part name based on the data on the customer name, the customer designated part name, the common part name, and the alternative part name included in the proposed alternative part data for the knowledge data 230 in which the replacement approval or disapproval is recorded.

If proposed alternative part data that is not subjected to this process yet remains in the replacement proposal data in which the replacement approval or disapproval is recorded (“NO” at step S7-6), the management computer 21 returns the process to step S7-1 and performs the process on the next proposed alternative part data. The management computer 21 repeats the process from steps S7-1 to S7-6 until the process on all the proposed alternative part data is finished.

If the process on all the proposed alternative part data is finished (“YES” at step S7-6), the management computer 21 finishes this process.

As a consequence, the order data 240, in which the replacement proposal reflects, is registered in the order-data storage unit 24. In addition, the knowledge data 230 on the information as to whether use of the proposed alternative part is approved or disapproved and information on the part to be used by the customer is recorded in the knowledge-data storage unit 23.

The information on this order data 240 is transmitted to the next step. A person in charge of the next step accesses the operational support server 20 using the person-in-charge-of-next-step terminal 32 and performs an operation of the next step based on the order data 240.

If the customer who places the order for manufacturing printed boards changes the design, the customer transmits change request data from the customer terminal 40 to the person-in-charge terminal 30. The person in charge inputs change information on the order information based on this change request data using the person-in-charge terminal 30. The management computer 21 of the operational support server 20 performs a part-table registration process based on the input data (at step S8-1). Specifically, the management computer 21 records the order data 240 including the part table data in the change request data. In this case, the management computer 21 records the order data 240 in which the system version is upgraded from that included in the previously registered order data 240. The registered part table is displayed on the part table screen 60 displayed on the person-in-charge terminal 30 as shown in FIG. 15.

The management computer 21 performs a part-table check process (at step S8-2). The part-table check process is performed similarly to the part-table check process at step S1-2 in the new registration process.

The management computer 21 specifies the previously registered part table corresponding to the part table (target part table) for which the change request is transmitted, as a reference part table. Specifically, the management computer 21 specifies the order data 240 having a latest version and a latest user version among pieces of order data 240 including the same customer name, board name, PWB part name, and PCB part name as the customer name, the board name, the PWB part name, and the PCB part name in the change-requested part table. It is noted that a system version allocated a greatest number is the latest system version. In addition, among the same system version, the system version corresponding to the user version allocated a greatest number is the Latest system version. Due to this, the order data 240 including the system version allocated the greatest number and the user version allocated the greatest number is specified as the order data 240 on the comparison target, previously registered part table. The management computer 21 performs a difference output process for a difference between the part table of the order data 240 thus specified and the change-requested part table (at step S8-3).

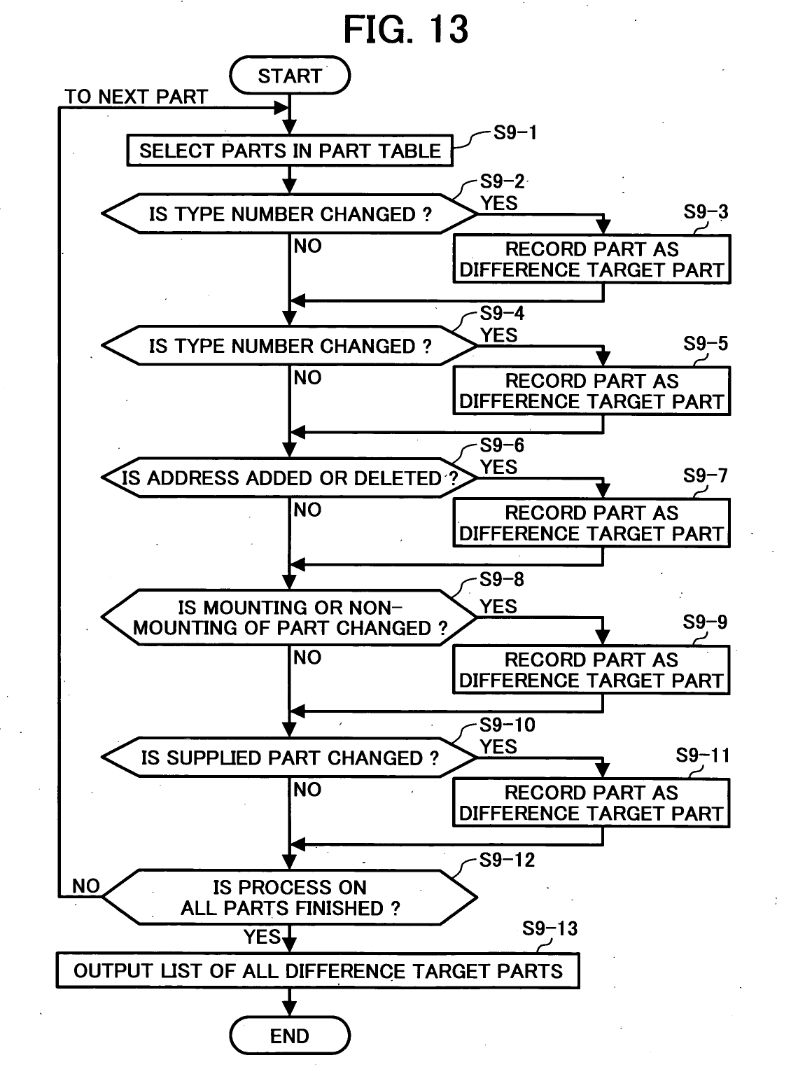

As shown in FIG. 13, the management computer 21 sequentially selects parts in the change-requested part table (target part table) (at step S9-1). The management computer 21 checks whether each part is an added or a deleted part (at step S9-2). Specifically, the management computer 21 checks whether the same part name as the part name of the part in the target part table is present in the reference part table. If the same part name is not present in the reference part table, this indicates that this part is an added part. If the same part name is present in the reference part table, the management computer 21 records a reference flag while associating the flag with the corresponding part in the reference part table.

If the part is an added or a deleted part (“YES” at step S9-2), the management computer 21 records difference part data on this part as a difference target part (at step S9-3). If the management computer 21 is to record the difference part data for the first time in the difference output process, the management computer 21 records the difference data 242 in which the customer name, the target-part-table identification information, and the standard table identification information are set. If the management computer 21 is to record the difference part data, the management computer 21 records the difference part data in the difference table data area of this difference data 242. Specifically, if the part is an added part, the management computer 21 records “added” as the difference type, and the part name and the like of the added part as the difference part data. If the part is a deleted part, the management computer 21 records “deleted” as the difference type, the part name and the like of the deleted part as the difference part data. The management computer 21 moves the process to step S9-4. If the part is not the added or deleted part (“NO” at step S9-2), the management computer 21 moves the process directly to step S9-4.

The management computer 21 checks whether the type number of this part is changed (at step S9-4). Specifically, the management computer 21 compares the type number of this part in the target part table with that in the reference part table. If the type number is changed (“YES” at step S9-4), the management computer 21 records difference part data as a difference target part (at step S9-5). Specifically, the management computer 21 records “type number changed” as the difference type, the part name, and the like. The management computer 21 moves the process to step S9-6. If the part number is not changed (“NO” at step S9-4), the management computer 21 moves the process directly to step S9-6.

The management computer 21 checks whether an address is added or deleted for this part (at step S9-6). Specifically, the management computer 21 compares the address information on this part included in the target part table with that in the reference part table. If the address is added or deleted (“YES” at step S9-6), the management computer 21 records difference part data as a difference target part (at step S9-7). Specifically, if the address is added, the management computer 21 records “address added” as the difference type, the part name, the added address, and the like. If the address is deleted, the management computer 21 records “address deleted” as the difference type, the part name, the deleted address, and the like. The management computer 21 moves the process to step S9-8. If the address is not added or deleted (“NO” at step S9-6), the management computer 21 moves the process directly to step S9-8.

The management computer 21 checks whether mounting or non-mounting of this part is changed (at step S9-8). Specifically, the management computer 21 compares information on mounting or non-mounting for each address of this part in the target part table with that in the reference part table. If the mounting or non-mounting of the part is changed (“YES” at step S9-8), the management computer 21 records difference part data as a difference target part (at step S9-9). Specifically, if mounting is changed to non-mounting, the management computer 21 records “changed from mounting to non-mounting” as the difference type, the part name, the target address, and the like. If the non-mounting is changed to the mounting, the management computer 21 records “changed from non-mounting to mounting” as the difference type, the part name, the target address, and the like. The management computer 21 then moves the process to step S9-10. If the mounting or non-mounting of the part is not changed (“NO” at step S9-8), the management computer 21 moves the process directly to step S9-10.

The management computer 21 checks whether a supplied part is changed for this part (at step S9-10). Specifically, the management computer 21 compares a setting of a supplied part flag for this part in the target part table with that in the reference part table. If the supplied part is changed (“YES” at step S9-10), the management computer 21 records difference part data as a difference target part (at step S9-11). Specifically, if the supplied part flag set in the reference part table is deleted in the target part table, the management computer 21 records “supplied part setting deleted” as the difference type, the part name, and the like. If the supplied part flag that is not set in the reference part table is set in the target part table, the management computer 21 records “supplied part changed” as the difference type, the part name, and the like. The management computer 21 moves the process to step S9-12. If the supplied part is not changed (“NO” at step S9-10), the management computer 21 moves the process directly to step S9-12.

If a part that is not subjected to this process yet remains in the target part table or a part for which a reference flag is not set in the reference part table is present (“NO” at step S9-12), the management computer 21 returns the process to step S9-1. If the part that is not subjected to this process yet remains in the target part table, the management computer 21 performs the process on the next part in the target part table. If the process on all the parts in the target part table is finished, the management computer 21 sequentially performs the process on the parts for each of which the reference flag is not set in the reference part table. The management computer 21 repeats the process from steps S9-1 to S9-12 until the process on all the part in the target part table is finished and the part for which the reference flag is not set in the reference part table is not present.

If the process on all the parts in the target part table is finished, the management computer 21 determines the part for which the reference flag is not set in the reference part table as a deleted part. At step S9-3, the management computer 21 records each of these parts as a difference target part. Specifically, the management computer 21 records “deleted” as the difference type and the part name for each of these parts.

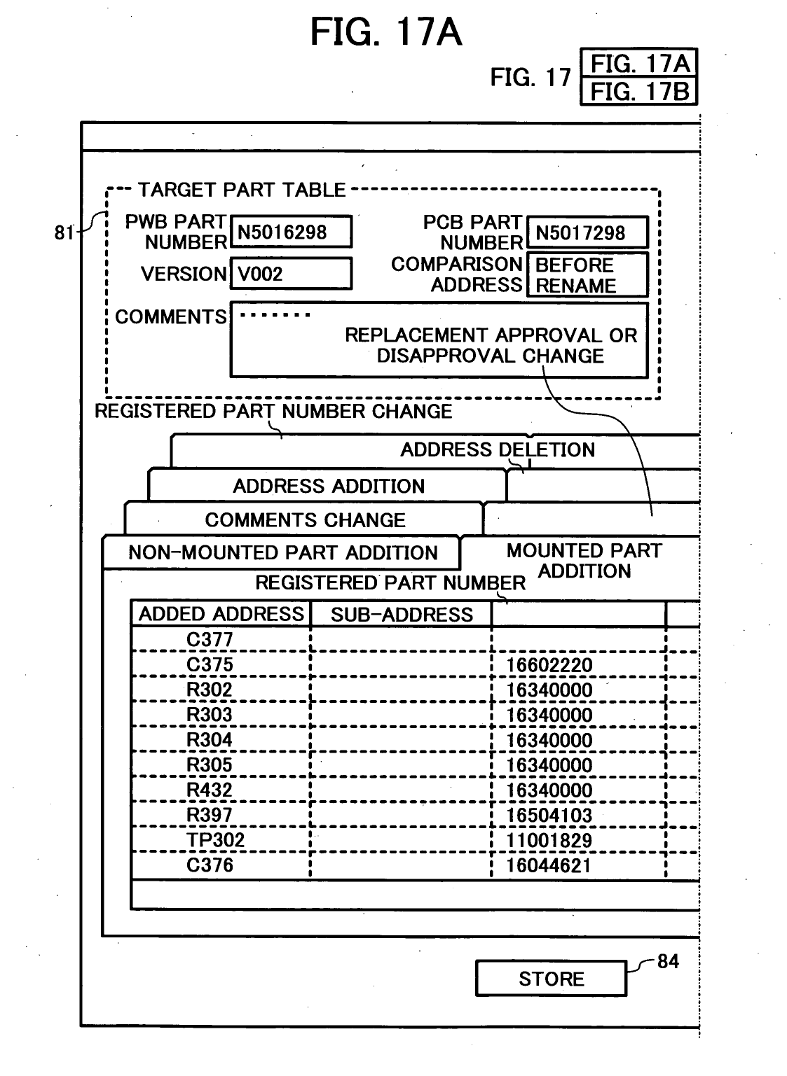

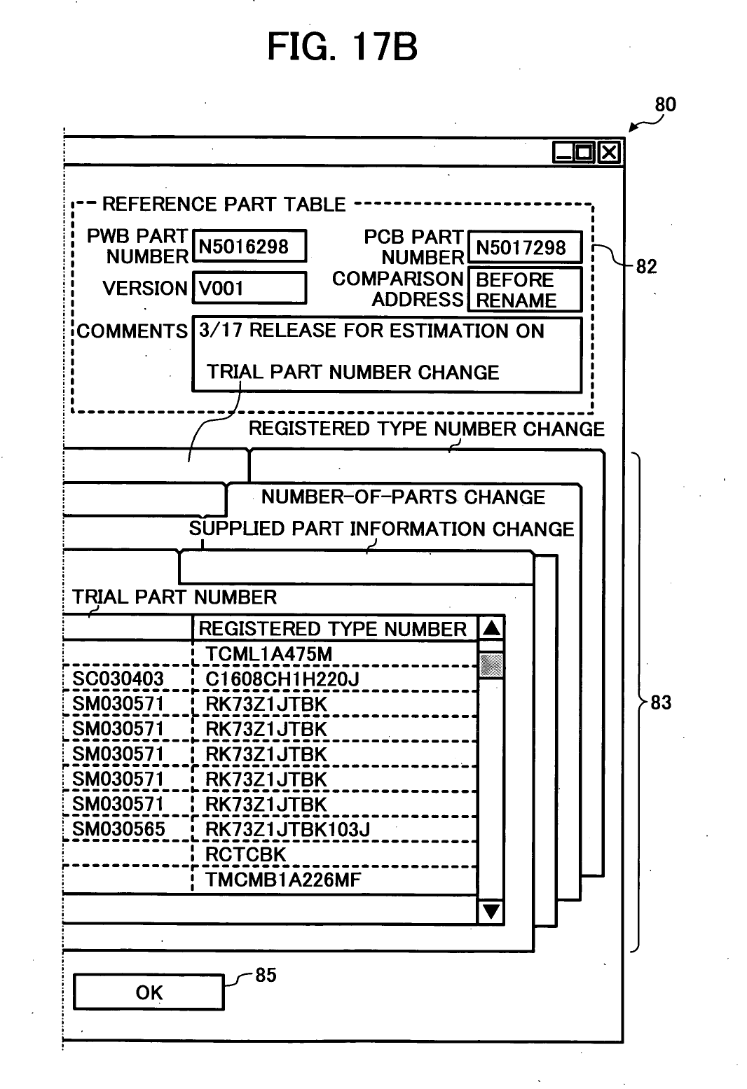

If the process on all the parts in the target part table is finished and the part for which the reference flag is not set in the reference part table is not present (“YES” at step S9-12), the management computer 21 outputs a list of all the difference target parts (at step S9-13). Thus, a difference list screen 80 shown in FIG. 17 is displayed.

As shown in FIG. 17, the difference list screen 80 includes a target part table display area 81, a reference part table display area 82, a difference list display area 83, a store button 84, and an OK button 85. In the target part table display area 81, the PWB part number, the PCB part number, the system version, a comparison address, and comments for the target part table are displayed based on the order data on the target part table of the difference data 242. In the reference part table area 83, the PWB part number, the PCB part number, the system version, a comparison address, and comments for the reference part table are displayed based on the order data 240 on the reference part table. In the difference list display area 83, a difference list on not-mounted part addition, mounted part addition, supplied part information change, registered part number change, trial part number change, registered type number change, address addition, address deletion, number-of-parts change, comments change, or replacement approval or disapproval change is displayed by selecting one of these items. Specifically, the management computer 21 displays a difference list in each item display area of the difference list display area 83 based on the difference type of the difference data 242. In FIG. 17, the mounted part addition item is selected and the difference list corresponding to the mounted part addition item is displayed. Specifically, the difference list on mounted parts of the difference type “added” is displayed.

The person in charge checks the difference list on this difference list screen 80 and clicks the OK button 85 when there is no problem. If the difference list is to be separately recorded, the person in charge clicks the store button 84. If the person in charge then clicks the OK button 85, the difference output process is finished.

The management computer 21 performs a part-information search process based on the difference data 242 output in the difference output process (at step S8-4). Specifically, the management computer 21 performs the same process as the part search process in the new registration process for the part of the difference type “added”.

The management computer 21 performs an alternative-part consideration process for the part of the difference type “added” (at step S8-5). Specifically, the management computer 21 performs the same process as the alternative-part consideration process in the new registration process for the part of the difference type “added”.

By performing these processes, the order data 240, in which the replacement proposal result reflects, for the added part is registered in the order-data storage unit 24. In addition, the knowledge data 230 on the information as to whether use of the proposed alternative part is approved or disapproved and the information on the part to be used by the customer is recorded in the knowledge-data storage unit 23.

The information on this order data 240 and that on the difference data 242 are transmitted to the next step. The person in charge of the next step accesses the operational support server 20 using the person-in-charge-of-next-step terminal 32, and performs an operation of the next step based on the order data 240 and the difference data 242.

If the common part data 220 registered in the common-part-data storage unit 22 is updated, the management computer 21 performs a common part table difference output process on each latest order data 240 of the registered order data 240. If the management computer 21 records the difference data 242, the management computer 21 outputs the difference data 242 while associating the difference data 242 with the part-table identification table constituted by the customer name, the board name, the PWB part number, the PCB part number, the system version, and the user version.

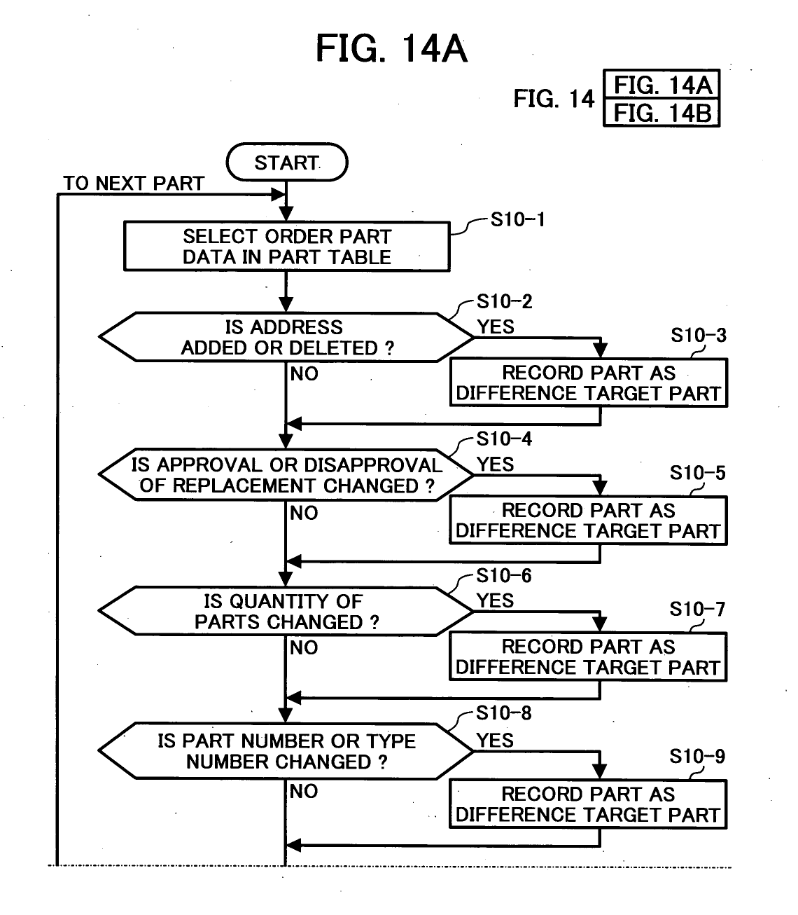

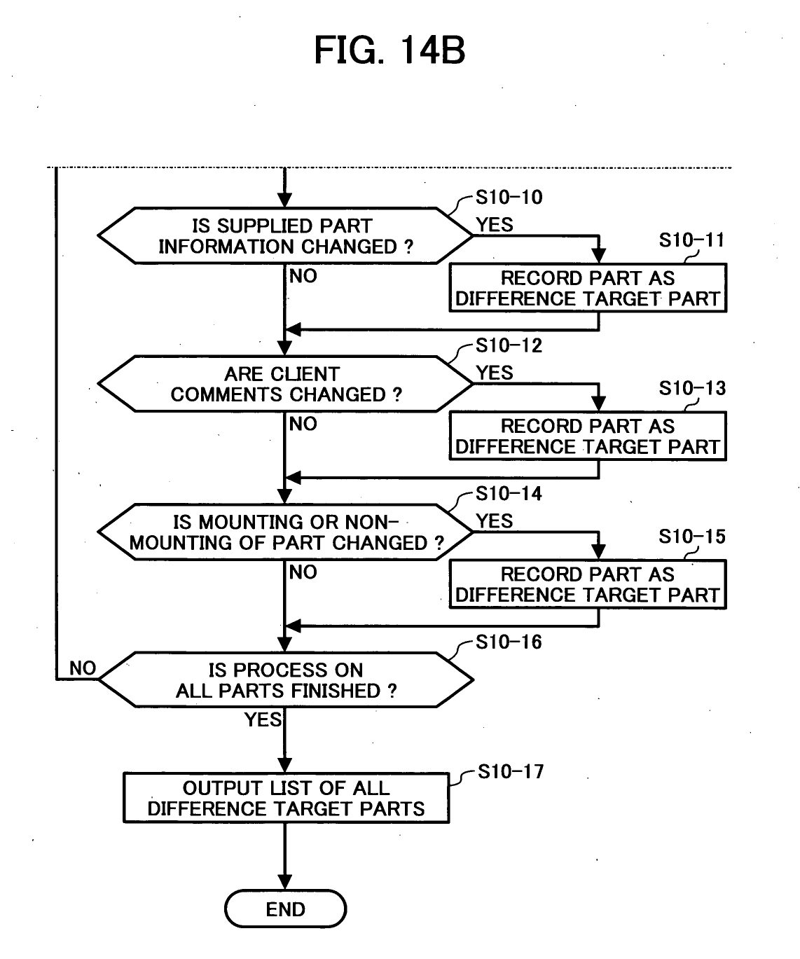

As shown in FIG. 14, the management computer 21 sequentially selects order part data in the part table data in the selected latest order data 240 (at step S10-1). The management computer 21 checks whether an address is added or deleted (at step S10-2).

If the address is added or deleted (“YES” at step S10-2), the management computer 21 records difference part data as a difference target part (at step S10-3). In this common part table difference output process, if the difference part data is first recorded, the management computer 21 records the difference data 242 in which the customer name and the target-part-table identification information are set. If the management computer 21 records the difference part data, the management computer 21 records the difference part data in the difference table data area of this difference data 242. Specifically, if the address is added, the management computer 21 records, as the difference part data, “address added” as the difference type, the added address, and the part name of the target part. If the address is deleted, the management computer 21 records, as the difference part data, “address deleted” as the difference type, the deleted address, and the part name of the target part. The management computer 21 moves the process to step S10-4. If the address is not added or deleted (“NO” at step S10-2), the management computer 21 moves the process directly to step S10-4.

The management computer 21 checks whether the replacement approval or disapproval is changed for the part of this order part data (at step S10-4). If the replacement approval or disapproval is changed (“YES” at step S10-4), the management computer 21 records difference part data as a difference target part (at step S10-5). Specifically, if the replacement approval or disapproval is changed to the replacement approval, the management computer 21 records “changed to replacement approval” as the difference type, and the part name. If the replacement approval disapproval is changed to the replacement disapproval, the management computer 21 records “changed to replacement disapproval” as the difference type, and the part name. The management computer 21 moves the process to step S10-6. If the replacement approval or disapproval is not changed (“NO” at step S10-4), the management computer 21 moves the process directly to step S10-6.

The management computer 21 checks whether the number of parts is changed for the part of this order part data (at step S10-6). If the number of parts is changed (“YES” at step S10-6), the management computer 21 records difference part data as a difference target part (at step S10-7). Specifically, the management computer 21 records “the number of parts changed” as the difference type, the part name, the number of parts before change, and the number of parts after change, and the like. The management computer 21 moves the process to step S10-8. If the number of parts is not changed (“NO” at step S10-6), the management computer 21 moves the process directly to step S10-8.

The management computer 21 checks whether the part number or type number is changed for the part of this order part data (at step S10-8). If the part number or type number is changed (“YES” at step S10-8), the management computer 21 records difference part data as a difference target part (at step S10-9). Specifically, if the part number is changed, the management computer 21 records “part number changed” as the difference type, the part number before change, the part number after change, and the part name. If the type number is changed, the management computer 21 records “type number changed” as the difference type, the type number before change, the type number after change, and the part name. The management computer 21 moves the process to step S10-10. If no part number or type number is changed (“NO” at step S10-8), the management computer 21 moves the process directly to step S10-10.

The management computer 21 checks whether supplied part information is changed for the part of this order part data (at step S10-10). If the supplied part information is changed (“YES” at step S10-10), the management computer 21 records difference part data as a difference target part (at step S10-11). Specifically, the management computer 21 records “supplied part deleted” as the difference type, the part name, and the like. The management computer 21 moves the process to step S10-12. If the supplied part is not changed (“NO” at step S10-10), the management computer 21 moves the process directly to step S10-12.

The management computer 21 checks whether customer comments are changed for the part of this order part data (at step S10-12). If the comments are changed (“YES” at step S10-12), the management computer 21 records the difference part data as a difference target part (at step S10-13). Specifically, the management computer 21 records “comments changed” as the difference type, the comments before change, the comments after change, the part name, and the like. The management computer 21 moves the process to step S10-14. If the comments are not changed (“NO” at step S10-12), the management-computer 21 moves the process directly to step S10-14.

The management computer 21 checks whether mounting or non-mounting is changed for the part of this order part data (at step S10-14). If the mounting or non-mounting is changed (“YES” at step S10-14), the management computer 21 records difference part data as a difference target part (at step S10-15). Specifically, if mounting is changed to non-mounting, the management computer 21 records “changed from mounting to non-mounting”, the part name, and the like. If non-mounting is changed to mounting, the management computer 21 records “changed from non-mounting to mounting”, the part name, and the like. The management computer 21 moves the process to step S10-16. If mounting or non-mounting is changed (“NO” at step S10-14), the management computer 21 moves the process directly to step S10-16.

If order part data that is not subjected to this process yet remains in the part table data included in the order data 240 (“NO” at step S10-16), the management computer 21 returns the process to step S10-1 and performs the process on the next order part data. The management computer 21 repeats the process from steps S10-1 to S10-16 until the process on all the order part data is finished.

If the process on all the order part data is finished (“YES” at step S10-16, the management computer 21 outputs a list of all of the recorded difference target parts (at step S10-17). Thus, the difference list screen accompanying the common part registration change is displayed on the person-in-charge terminal 30. The person in charge confirms this screen.

The management computer 21 performs a part-information search process and a replacement consideration process based on the difference data that is output to accompany this common part registration change. These processes are performed similarly to the part-information search process (at step S8-4) and the replacement consideration process (at step S8-5) in the change registration process, respectively.

The order data 240, in which the replacement proposal result reflects, is thereby registered in the order-data storage unit 24 for the difference data output to accompany the common part registration change. In addition, the knowledge data 230 on the information as to whether use of the proposed alternative part is approved or disapproved and the information on the part to be used by the customer is recorded in the knowledge-data storage unit 23.

The information on this order data 240 and that on the difference data 242 are transmitted to the next step. The person in charge of the next step accesses the operational support server 20 using the person-in-charge-of-next-step terminal 32, and performs an operation of the next step based on the order data 240 and the difference data 242.

The embodiment of the present invention can exhibit the following advantages. According to this embodiment, the management computer 21 searches the common-part-data storage unit 22 for the part in the part table data included in the order data 240 recorded in the order-data storage unit 24, and extracts the common part data 220 on the possible replacement common part. If the priority order of the approval status of the customer designated part is lower than that of the approval status of the possible replacement common part, the management computer 21 registers the possible alternative part in the replacement proposal. In this case, if the knowledge data 230 on this customer designated part for this customer indicates “disapproval” as the past customer approval or disapproval of replacement, the management computer 21 does not register the possible replacement common part in the replacement proposal. The management computer 21 submits the replacement proposal to the customer. The management computer 21 records data on the alternative part in the order-data storage unit 24 based on data on the reply to the replacement proposal, and records data on the customer approval or disapproval for this replacement proposal in the knowledge-data storage unit 23. By doing so, if the alternative part that can replace the customer designated part is extracted from among the common parts registered in the common-part-data storage unit 22 and proposed to the customer, and customer approval for this alternative part is obtained, this alternative part can be used. In addition, the management computer can make a replacement proposal while referring to the past customer approval or disapproval for the replacement proposal. Therefore, by replacing the customer designated part by the possible replacement common part, products can be provided at a low cost within a short delivery time using the common part.

Furthermore, according to this embodiment, the management computer 21 searches the knowledge-data storage unit 23 for each customer designated part recorded in the part table data. In addition, the management computer 21 extracts data on the previously proposed alternative part and the past replacement approval or disapproval if the part is recorded in the knowledge-data storage unit 23. If the past replacement approval or approval indicates “approval”, the management computer 21 selects this previously proposed alternative part as the proposed alternative part, and determines that the customer designated part is irreplaceable if the past replacement approval or disapproval indicates “disapproval”. It is thereby possible to propose the previously proposed and approved alternative part as an alternative part. If the proposed alternative part is previously proposed as an alternative part but disapproved, it is possible not to replace the customer designated part by the proposed alternative part. It is thereby possible to make the replacement proposal while causing information to be shared and intention of the customer to be reflected in the proposal.

According to this embodiment, the management computer 21 compares the part table data after the change by the customer with the part table data before the change recorded in the constituent part data storage unit 24, and outputs the difference data 242. The management computer 21 further performs the part-information search process and the alternative-part consideration process based on this difference data 242. It is thereby possible to allocate the common part and make the alternative part proposal only for a changed point between the part table data changed by the customer and the part table data before the change.

According to this embodiment, the common part data 220 includes data on the approval status. The management computer 21 displays information on the approval status on the person-in-charge terminal 30 based on the common part data 220 on the alternative part so as to urge the person in charge to consider the replacement. The management computer 21 also generates the replacement proposal data in which data on the replacement proposal approval or disapproval input using the person-in-charge terminal 30 reflects. It is thereby possible to support the person in charge when the person in charge considers the content of the replacement proposal.

This embodiment can be modified. According to this embodiment, the person in charge considers the proposed alternative part from among the searched possible alternative parts, and the part selected by the person in charge is proposed to the customer as the alternative part. Alternatively, if a plurality of possible alternative parts are searched and it is found that a plurality of possible proposed alternative parts are present as a result of a consideration of the person in charge, then the plural parts can be proposed to the customer as alternative parts and the customer can be able to select one alternative part from among the proposed alternative parts. The intention of the customer can be thereby reflected in the replacement proposal.

According to the embodiments described above, it is possible to provide a product at a low cost within a short delivery time.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of managing information on at least one part to be used to manufacture a product, comprising:
creating part data that includes information on a part designated by a customer to be used to manufacture a product;
creating common-function-part data that includes at least two common-function-parts that have substantially common functions and priority information of each of the common-function-parts;
acquiring replacement-possibility data indicative of whether replacement of designated part with an alternative part is possible;
extracting an alternative part for the designated part based on the common-function-part data;
determining whether to replace the designated part with the alternative part based on the common-function-part data and the replacement-possibility data.

2. The method according to claim 1, further comprising:
creating proposal data to propose the replacement of the designated part with the alternative part to the customer, when the designated part has lower priority than the alternative data and when the replacement-possibility data indicates that the replacement of the designated part with the alternative part is possible;
outputting the proposal data to the customer; and
receiving a reply that indicates whether to approve proposed replacement from the customer; wherein
the determining includes determining whether to replace the designated part with the alternative part based on the reply.

3. The method according to claim 2, further comprising:
updating the part data and the replacement-possibility data based on the reply.

4. The method according to claim 3, further comprising:
receiving, from the customer, change data that includes part data updated by the customer; and
creating difference data indicative of a difference between the part data that has been created and part data received from the customer, wherein
the extracting, the creating, and the updating are performed further based on the difference data.

5. A computer-readable recording medium that stores therein a computer program for managing information on at least one part to be used to manufacture a product, the computer program making a computer execute:
creating part data that includes information on a part designated by a customer to be used to manufacture a product;
creating common-function-part data that includes at least two common-function-parts that have substantially common functions and priority information of each of the common-function-parts;
acquiring replacement-possibility data indicative of whether replacement of designated part with an alternative part is possible;
extracting an alternative part for the designated part based on the common-function-part data;
determining whether to replace the designated part with the alternative/part based on the common-function-part data and the replacement-possibility data.

6. The computer-readable recording medium according to claim 5, wherein the computer program further makes the computer execute:
creating proposal data to propose the replacement of the designated part with the alternative part to the customer, when the designated part has lower priority than the alternative data and when the replacement-possibility data indicates that the replacement of the designated part with the alternative part is possible;
outputting the proposal data to the customer; and
receiving a reply that indicates whether to approve proposed replacement from the customer; wherein
the determining includes determining whether to replace the designated part with the alternative part based on the reply.

7. The computer-readable recording medium according to claim 6, wherein the computer program further makes the computer execute:
updating the part data and the replacement-possibility data based on the reply.

8. The computer-readable recording medium according to claim 7, wherein the computer program further makes the computer execute:
receiving, from the customer, change data that includes part data updated by the customer; and
creating difference data indicative of a difference between the part data that has been created and part data received from the customer, wherein
the extracting, the creating, and the updating are performed further based on the difference data.

9. An apparatus for managing information on at least one part to be used to manufacture a product, comprising:
a part-data creating unit configure to create part data that includes information on a part designated by a customer to be used to manufacture a product;
a common-function-part data creating unit configured to create common-function-part data that includes at least two common-function-parts that have substantially common functions and priority information of each of the common-function-parts;
an acquiring unit configured to acquire replacement-possibility data indicative of whether replacement of designated part with an alternative part is possible;
an extracting unit configured to extract an alternative part for the designated part based on the common-function-part data;
a determining unit configured to determine whether to replace the designated part with the alternative part based on the common-function-part data and the replacement-possibility data.

10. The apparatus according to claim 9, further comprising:
a proposal-data creating unit configured to create proposal data to propose the replacement of the designated part with the alternative part to the customer, when the designated part has lower priority than the alternative data and when the replacement-possibility data indicates that the replacement of the designated part with the alternative part is possible;
an output unit configured to output the proposal data to the customer; and
a reply receiving unit configured to receive a reply that indicates whether to approve proposed replacement from the customer; wherein
the determining unit is configured to determine whether to replace the designated part with the alternative part based on the reply.

11. The apparatus according to claim 10, further comprising:
an updating unit configured update the part data and the replacement-possibility data based on the reply.

12. The apparatus according to claim 11, further comprising:
a change-data receiving unit configured to receive, from the customer, change data that includes part data updated by the customer; and
a difference-data creating unit is configured to create difference data indicative of a difference between the part data that has been created and part data received from the customer, wherein
the extracting unit is configured to extract an alternative part further based on the difference data,
the proposal-data creating unit is configured to create proposal data further based on the difference data, and
the updating unit is configured to update the part data and the replacement-possibility data further based on the difference data.
